(19) United States
(12) Patent Application Publication
(10) Pub. No.: US 2025/0145820 A1
(43) Pub. Date: May 8, 2025

(54) POLYETHYLENE GLYCOL-BASED POLYMER PROCESSING AIDS

(71) Applicant: ExxonMobil Chemical Patents Inc., Baytown, TX (US)

(72) Inventors: Nino RUOCCO, Houston, TX (US); Michael A. LEAF, Baytown, TX (US); Danny VAN HOYWEGHEN, Heverlee (BE); Donald A. WINESETT, Houston, TX (US)

(21) Appl. No.: 18/730,070

(22) PCT Filed: Dec. 14, 2022
(86) PCT No.: PCT/US2022/081532

§ 371 Date: Jul. 18, 2024

Related U.S. Application Data
(60) Provisional application No. 63/267,640, filed on Feb. 7, 2022.
(60) Provisional application No. 63/309,859, filed on Feb. 14, 2022.
(60) Provisional application No. 63/309,871, filed on Feb. 14, 2022.
(60) Provisional application No. 63/366,678, filed on Jun. 20, 2022.
(60) Provisional application No. 63/367,241, filed on Jun. 29, 2022.
(60) Provisional application No. 63/367,425, filed on Jun. 30, 2022.

(51) Int. Cl. C08L 71/02; C08J 3/22; C08J 5/18

(52) U.S. Cl. CPC C08L 71/02; C08J 3/22; C08J 5/18; C08J 2371/02; C08J 2423/06; C08L 2203/16; C08L 2205/02; C08L 2205/03; C08L 2205/06; C08L 2310/00

(57) ABSTRACT

Methods and compositions for processing polymers with fluorine-free polymer processing aids (PPAs) are described. The methods can include extruding a polymer composition, the polymer composition optionally containing polyethylene glycol (PEG) polymer processing aid, to make a polymeric film; developing one or more melt fractures in the polymeric film; and in response to developing the one or more melt fractures, feeding a masterbatch of polymer processing agent. The masterbatch can include, and preferably can consist essentially of, 1 to 50 wt % PEG having weight average molecular weight (Mw) less than 10,000 g/mol; a carrier resin; and, optionally, one or more non-PPA additives.

### CROSS-REFERENCED RELATED APPLICATIONS

This application claims the benefit of U.S. Provisional Application 63/267,640 filed Feb. 7, 2022 entitled “Fluorine-Free Polymer Processing Aids Including Polyethylene Glycols”, and also claims the benefit of U.S. Provisional Application 63/309,859 filed Feb. 14, 2022 entitled “Fluorine-Free Polymer Processing Aids Including Polyethylene Glycols”, and also claims the benefit of U.S. Provisional Application 63/309,871 filed Feb. 14, 2022 entitled “Fluorine-Free Polymer Processing Aid Blends”, and also claims the benefit of U.S. Provisional Application 63/366,678 filed Jun. 20, 2022 entitled “Fluorine-Free Polymer Processing Aid Blends”, and also claims the benefit of U.S. Provisional Application 63/367,241 filed Jun. 29, 2022 entitled “Polyethylene Glycol-Based Polymer Processing Aids”, and also claims the benefit of U.S. Provisional Application 63/367,425 filed Jun. 30, 2022 entitled “Polyethylene Glycol-Based Polymer Processing Aid Masterbatches”, the entireties of which are incorporated by reference herein.

### FIELD

The present disclosure relates to additives for polyolefin polymers (such as polyethylene), as well as the polymers themselves, methods of making them, and articles made therefrom.

### BACKGROUND

Polyolefin polymer compositions are in high demand for many applications, including various films (such as cast films, shrink films, and blown films), sheets, membranes such as geomembranes, sacks, pipes (e.g., polyethylene of raised temperature (PE-RT) pipes, utility pipes, and gas distribution pipes), roto-molded parts, blow-molded flexible bottles or other containers, and various other blow molded/extruded articles such as bottles, drums, jars, and other containers. These applications have been commonly made from, for example, polyethylene polymers.

Polyolefin polymers are most commonly produced and sold as pellets, formed in post-polymerization reactor finishing processes (such as extrusion of polymer product that is in an at least partially molten state, followed by pelletization). Additives are commonly blended into the polymer product as part of this finishing process, such that the polymer pellets comprise the polymer itself and one or more additives.

Common additives, particularly for polymers such as polyethylenes intended for use as films, sacks, and other similar articles, include polymer processing aids (PPAs), which help make the pellets easier to manipulate in downstream manufacturing processes (such as extrusion, rolling, blowing, casting, and the like). Adequate amounts of PPA, among other things, help eliminate melt fractures in films made from the polymer pellets. This is particularly so for polymer pellets exhibiting relatively higher viscosity in extrusion processes. Melt fracture is a mechanically-induced melt flow instability which occurs, e.g., at the exit of an extrusion die and typically in conditions of high shear rate. Pinhole, linear, and annular die geometries are among those that can induce melt fracture. There are different mechanical regimes that describe PE melt fracture, but all manifest as a very rough polymer surface which persists as the polymer crystallizes. Commonly in the blown film industry, a rough array of sharkskin like patterns develop on the film surface, often with a characteristic size from the mm to cm scale, and they depend on both the flow profile and rheology of the polyolefin polymer (e.g., polyethylene).

Melt fracture can adversely affect film properties, distort clarity, and reduce gauge uniformity. Thus, melt fracture-prone polymer grades, as noted, often rely on a PPA.

The most common PPAs are or include fluoropolymers (fluorine-containing polymers). It is, however, desired to find alternative PPAs that do not include fluoropolymers and/or fluorine, while maintaining the effectiveness of fluoropolymer-based PPAs in preventing melt fractures.

Some references of potential interest in this regard include: U.S. Pat. Nos. 10,982,079; 10,242,769; 10,544,293; 9,896,575; 9,187,629; 9,115,274; 8,552,136; 8,455,580; 8,728,370; 8,388,868; 8,178,479; 7,528,185; 7,442,742; 6,294,604; 5,015,693; 4,855,360; and 4,540,538; U.S. Patent Publication Nos. 2003/0040695, 2005/0070644, 2008/0132654, 2014/0182882, 2014/0242314, 2015/0175785, 2016/0145427, 2016/0229994, 2017/0342245, 2020/0325314; as well as WO2020/146351; WO2011/028206, CN104558751, CN112029173, KR10-2020-0053903, CN110317383, JP2012009754A, WO2017/077455, CN108481855, CN103772789, CN107540920.

### SUMMARY

The present disclosure relates to polymer compositions, their methods of manufacture, and articles including and/or made from the polymer compositions. In a particular focus, the polymer compositions may be polyolefin compositions, preferably polyethylene compositions. The polymer compositions can also include a PPA that is free or substantially free of fluorine; and, accordingly, the polymer compositions can be free or substantially free of fluorine. In this application, “substantially free” permits trace amounts (e.g., 10 ppm or less, preferably 1 ppm or less, such as 0.1 ppm or less) of an impurity (e.g., fluorine), but well below the amount that would intentionally be included in a polymer composition (e.g., in the case of fluorine, about 100 ppm of fluorine atoms by mass of polymer product in a typical case where such additives are included).

The present inventors have found that polyethylene glycol (PEG) can be an advantageous replacement of fluorine-based PPAs in polyolefin compositions. The PEG-based PPA therefore can comprise at least 80 wt % (on the basis of total mass of the PPA) PEG, more preferably at least 90 wt %, or at least 99 wt %, such as at least 99.9 or 99.99 wt % PEG; or, the PPA can consist or consist essentially of the PEG. The PEG can have molecular weight less than 40,000 g/mol, preferably less than 10,000 g/mol, such as within the range from 1,500 to 35,000 g/mol, such as 5,000 to 12,000 g/mol, or 6,500 to 9,500 g/mol.

Furthermore, the PPA (and therefore polymer compositions) can also or instead be substantially free of other processing aids and similar compounds besides PEG (e.g., free of polycaprolactones, silicones, and other compositions or additives included in the composition for the purpose of reducing melt fracture and/or preventing sticking of the polymer composition when processed through extrusion equipment such as an extruder die). The PEG PPA may optionally be provided to the polymer composition in a masterbatch that comprises, or more preferably consists or consists essentially of: (i) the PEG; (ii) a carrier resin; and (iii) optionally, one or more non-PPA additives (e.g., antioxidant additives; antislip agents; UV stabilizers; antiblock agents; catalyst neutralizers; and the like). “Consist essentially of” in this context means that the PPA (or PPA masterbatch) does not intentionally include components other than those components (including optional components) just mentioned, and sometimes further may be substantially free of any one or more of the optional additives just mentioned. The polymer composition can likewise be substantially free of additives other than the PEG and optional non-PPA additives, such as the just-mentioned additives.

In various embodiments, the polymer compositions can be, e.g., polymer pellets; a polymer melt (as would be formed in an extruder such as a compounding extruder); reactor-grade polymer granules and/or polymer slurries; or other form of polymer composition containing the PPA and optionally one or more other additives.

The present disclosure also relates to films and/or other end-use articles made from such polymer compositions, and in particular instances can relate to cast or blown films, preferably blown films. Thus, the polyolefin compositions (e.g., polymer pellets) of various embodiments, and/or films or other articles made therefrom (e.g., blown films), are themselves free or substantially free of fluorine (or, at a minimum, free or substantially free of fluorine-based PPA). A fluorine-based PPA, as used herein, is a polymer processing aid or other polymeric additive containing fluorine. The compositions and/or films or other articles can likewise be substantially free of PPA other than PEG (although it may, in certain embodiments, also include the optional additives and/or carrier resin mentioned above).

It is also found, however, that the lower-molecular-weight PEG compositions can be difficult to handle (e.g., due to relatively lower melting points). Therefore, delivery systems and methods for the PEG PPA are also provided herein. One example includes the PEG masterbatches mentioned above. As another example, the PEG may be provided to a polymer composition (e.g., provided to a reactor grade polymer composition such as polymer granules as part of a polymer finishing process) in the form of a compacted composite or blend (e.g., compressed briquettes or pellets) comprising the PEG and one or more of the optional additives mentioned above (primary antioxidant, secondary antioxidant, slip agent, UV stabilizer, antiblock agent, catalyze neutralizer), or the PEG and a polymer solid, noting that the additive or polymer solid blend partner preferably has a higher melting point than the PEG with which it is blended, and also is stable (that is, a non-sticky solid) at 65° C. and 1 atm, preferably stable at even higher temperature (e.g., 70° C., 75° C., 100° C., 125° C., 150° C., or higher) at 1 atm.

Also provided herein are methods for deploying a PEG masterbatch or PEG-additive (or PEG-polymer) blend to polymer compositions. The PEG masterbatch or blend may, e.g., be deployed to reactor grade polymer (e.g., polymer granules) during a polymer finishing process, for instance as an additive that is blended with polymer granules during coextrusion and pelletization to form polymer pellets. A PEG masterbatch or blend can also or instead be deployed in a filmmaking process, such as during extrusion and/or blowing in filmmaking, in place of conventional PPA deployment in such processes. Such deployment could be continuous or, preferably, could comprise intermittent injections of PEG masterbatch into molten polymer being formed into film. Such intermittent injection has advantageously been found to maintain melt-fracture free film production while minimizing or entirely avoiding any adverse impacts on film properties due to excessive PEG loading, and further while avoiding excessive raw materials usage.

### BRIEF DESCRIPTION OF THE DRAWINGS

FIG. 1 is a schematic conceptually illustrating streaks of melt fractures and stripes of regions with melt fractures eliminated in a blown film during extrusion.

### DETAILED DESCRIPTION

### Definitions

For the purposes of the present disclosure, various terms are defined as follows.

The term “polyethylene” refers to a polymer having at least 50 wt % ethylene-derived units, such as at least 70 wt % ethylene-derived units, such as at least 80 wt % ethylene-derived units, such as at least 90 wt % ethylene-derived units, or at least 95 wt % ethylene-derived units, or 100 wt % ethylene-derived units. The polyethylene can thus be a homopolymer or a copolymer, including a terpolymer, having one or more other monomeric units. A polyethylene described herein can, for example, include at least one or more other olefin(s) and/or comonomer(s).

An “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 50 wt % to 55 wt %, it is understood that the mer unit in the copolymer is derived from ethylene in the polymerization reaction and said derived units are present at 50 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers and the like. “Different” as used to refer to mer units indicates that the mer units differ from each other by at least one atom or are different isomerically.

The term “alpha-olefin” or “«-olefin” refers to an olefin having a terminal carbon-to-carbon double bond in the structure thereof. R¹R²C═CH₂, where R¹ and R² can be independently hydrogen or any hydrocarbyl group; such as R¹ is hydrogen and R² is an alkyl group. A “linear alpha-olefin” is an alpha-olefin wherein R¹ is hydrogen and R² is hydrogen or a linear alkyl group. For the purposes of the present disclosure, ethylene shall be considered an α-olefin.

As used herein, the term “extruding” and grammatical variations thereof refer to processes that include forming a polymer and/or polymer blend into a melt, such as by heating and/or sheer forces, and then forcing the melt out of a die in a form or shape such as in a film, or in strands that are pelletized. Most any type of apparatus will be appropriate to effect extrusion such as a single or twin-screw extruder, or other melt-blending device as is known in the art and that can be fitted with a suitable die. It will also be appreciated that extrusion can take place as part of a polymerization process (in particular, in the finishing portion of such process) as part of forming polymer product (such as polymer pellets); or it can take place as part of the process for forming articles such as films from the polymer pellets (e.g., by at least partially melting the pellets and extruding through a die to form a sheet, especially when combined with blowing air such as in a blown film formation process). In the context of the present disclosure, extrusion in the finishing portion of polymerization processes may be referred to as compounding extrusion, and typically involves feeding additives plus additive-free (reactor grade) polymer to the extruder to form finished polymer product such as polymer pellets; while extrusion of polymer to make articles (e.g., extrusion of polymer pellets to make films) takes place conceptually “downstream” (e.g., at a later point, after polymer product has been formed including through compounding extrusion), and typically involves feeding optional additives plus additive-containing polymer to the extruder to form a polymeric article such as a film.

“Finishing” as used herein with reference to a polymerization process refers to post-polymerization reactor processing steps taken to form a finished polymer product, such as polymer pellets, with one example of a finishing process being the compounding extrusion just discussed. As the ordinarily skilled artisan will recognize, finishing is distinguished from, and conceptually takes place antecedent to, further processing of the finished polymer product into articles such as films.

A “PEG-based PPA composition” is a polymer processing aid composition containing polyethylene glycol.

### Polymers

In various embodiments, polymer compositions include one or more polymers, preferably polyolefin polymers. Examples include homopolymers (e.g., homopolymers of a C₂ to C₁₀ α-olefin, preferably a C₂ to C₆ α-olefin). Particular examples of homopolymers include homopolyethylene and polypropylene (hPP), with homopolyethylene preferred in the present disclosure. Homopolyethylene may be produced, e.g., by free radical polymerization in a high-pressure process, resulting typically in a highly branched ethylene homopolymer-often known as LDPE (low density polyethylene), having density less than 0.945 g/cm³, often 0.935 g/cm³ or less, such as within the range from 0.900, 0.905, or 0.910 g/cm³ to 0.920, 0.925, 0.927, 0.930, 0.935, or 0.945 g/cm³. Unless otherwise noted herein, all polymer density values are determined per ASTM D1505. Samples are molded under ASTM D4703-10a, procedure C, and conditioned under ASTM D618-08 (23°±2° C. and 50±10% relative humidity) for 40 hours before testing.

In another example, ethylene monomers may be polymerized via known gas, slurry, and/or solution phase polymerization (e.g., using catalysts such as chromium-based catalysts, or single-site catalysts such as Ziegler-Natta and/or metallocene catalysts, all of which are well known in the art of polymerization and not discussed further herein. Where a more highly linear ethylene homopolymer is produced (e.g., using gas or slurry phase polymerization with any of the above noted catalysts), it may be referred to as HDPE (high density polyethylene), typically having density 0.945 g/cm³ or greater, such as within the range from 0.945 to 0.970 g/cm³.

Yet further polymer examples include copolymers of two or more C₂ to C₄₀ α-olefins, such as C₂ to C₂₀ α-olefins, such as ethylene-α-olefin copolymers, or propylene-α-olefin copolymers (e.g., propylene-ethylene copolymers, or propylene-ethylene-diene terpolymers, sometimes known as EPDMs or PEDMs). Particular examples contemplated herein include copolymers of ethylene and one or more C₃ to C₂₀ α-olefin comonomers, such as C₄ to C₁₂ α-olefin comonomers (with 1-butene, 1-hexene, 1-octene, or mixtures of two or more of them being preferred in various embodiments). An ethylene copolymer (e.g., a copolymer of ethylene and one or more C₃ to C₂₀ α-olefins) can include ethylene-derived units in an amount of at least 80 wt %, or 85 wt %, such as at least 90, 93, 94, 95, or 96 wt % (for instance, in a range from a low of 80, 85, 90, 91, 92, 93, 94, 95, 96, or 97 wt %, to a high of 94, 95, 95.5, 96, 96.5, 97, 97.5, or 98 wt %, with ranges from any foregoing low value to any foregoing high value contemplated (provided the high is greater than the low) based on a total amount of ethylene-derived units and comonomer-derived units. For instance, the ethylene copolymer can include 88, 90, 92, 94 or 95 wt % to 97 or 98 wt % ethylene-derived units based on the total amount of ethylene-derived units and comonomer-derived units. The balance of the copolymer (on the basis of ethylene-derived units and comonomer-derived units) is comprised of the comonomer-derived units. For example, comonomer units (e.g., C₂ to C₂₀ α-olefin-derived units, such as units derived from butene, hexene, and/or octene) may be present in the ethylene copolymer from a low of 2, 2.5, 3, 3.5, 4, 4.5, 5, or 6 wt %, to a high of 3, 4, 5, 6, 7, 8, 9, 10, 15, or 20 wt %, with ranges from any foregoing low to any foregoing high contemplated (provided the high is greater than the low value).

For ethylene-based, propylene-based, or other α-olefin based copolymers, several suitable comonomers were already noted, although in various embodiments, other α-olefin comonomers are contemplated. For example, the α-olefin comonomer can be linear or branched, and two or more comonomers can be used, if desired. Examples of suitable comonomers include linear C₃-C₂₀ α-olefins (such as butene, hexene, octene as already noted), and α-olefins having one or more C₁-C₃ alkyl branches, or an aryl group. Examples can include propylene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. It should be appreciated that the list of comonomers above is merely exemplary, and is not intended to be limiting. In some embodiments, comonomers include propylene, 1-butene, 1-pentene, 4-methyl-1-pentene, 1-hexene, 1-octene and styrene.

In particular embodiments, the polymer can comprise or can be an ethylene copolymer (per those described above). The ethylene copolymer can be produced in gas, slurry, or solution phase polymerization, and some particularly preferred ethylene copolymers can be produced in gas or slurry phase polymerization, most preferably gas phase polymerization, as in a gas phase fluidized bed polymerization reactor. A particular example is a linear-low density polyethylene (LLDPE), a copolymer of ethylene and one or more α-olefins polymerized in the presence of one or more single-site catalysts, such as one or more Ziegler-Natta catalysts, one or more metallocene catalysts, and combinations thereof. Such LLDPE can have density within the range from a low of 0.900, 0.905, 0.907, 0.910 g/cm³ to a high of 0.920, 0.925, 0.930, 0.935, 0.940, or 0.945 g/cm³. LLDPE can be distinguished from the above-mentioned LDPE in several respects, many of which are well known in the art, including the degree of branching (sometimes referred to more specifically as long-chain branching) in the produced polymer, noting that LLDPE has substantially less (often little, if any) long chain branching. The polymer of the polymer composition preferably is or includes a metallocene-catalyzed LLDPE (mLLDPE).

mLLDPE as compared to Ziegler-Natta-catalyzed LLDPE can have one or both of the following distinguishing properties: (1) narrower molecular weight distribution (e.g., Mw/Mn of 5.0 or less, such as 4.5 or less, or 3.5 or less, or 3.0 or less, preferably within the range from a low of 1, 1.5, 2, or 2.5 to a high of 2.5, 3, 3.5, 4.0, 4.5, or 5.0 with ranges from any foregoing low end to any foregoing high end contemplated, provided the high end is greater than the low end); and/or (2) orthogonal composition distribution. The latter term refers to comonomer incorporation on individual chains of the polymer: in Ziegler-Natta catalyzed polymers such as ethylene copolymers, having a “conventional” composition distribution, comonomer is preferentially incorporated into smaller (a/ka/shorter or lower-molecular-weight) polymer chains, while larger (longer or higher-molecular weight) polymer chains have relatively less comonomer. On the other hand, an “orthogonal” composition distribution, and in particular a broad orthogonal composition distribution (BOCD) is known to result from certain metallocene catalysts or catalyst systems, wherein the reverse is the case: more comonomer is incorporated on longer polymer chains, while shorter chains have relatively less comonomer. This can particularly be the case when carrying out polymerization with mixed or multiple catalyst systems (e.g., two or more metallocene catalysts), wherein mLLDPE is obtained that has relatively broad MWD (like Ziegler-Natta catalyzed LLDPE), but also having BOCD (the reverse of Ziegler-Natta catalyzed LLDPE). In this regard, see paragraphs 0045-0046, 51, and 53 of U.S. patent application Ser. No. 17/661,958, entitled “Blends of Recycled Resins with Metallocene-catalyzed Polyolefins” and filed May 4, 2022, which description is incorporated herein by reference. In particular, such polymers may be copolymers of ethylene and a C₃ to C₂₀ α-olefin, such as a C₃ to C₁₂ α-olefin such as 1-butene, 1-hexene, and/or 1-octene, having 80 to 99 wt % units derived from ethylene and the balance derived from the α-olefin comonomer(s). Any of various property quantifications can be associated with a BOCD nature, such as one or more of: (i) T₇₅-T₂₅ value from 5 to 10 (where T₂₅ is the temperature in degrees Celsius at which 25% of the eluted polymer is obtained and T₇₅ is the temperature in degrees Celsius at which 75% of the eluted polymer is obtained via temperature rising elution fractionation (TREF)); (ii) a composition distribution breadth index (CDBI) less than about 40%, such as less than about 35%; and (iii) a first peak and a second peak in a comonomer distribution analysis, wherein the first peak has a maximum at a log (MW) value of from 4.0 to 5.4 and a TREF elution temperature from 70° C. to 100° C., and the second peak has a maximum at a log (MW) value of 5.0 to 6.0 and a TREF elution temperature of 40° C. to 60° C. Paragraphs 37 and 44 of U.S. patent application Ser. No. 17/661,958 describe the CDBI and TREF methods for determining these properties. Also or instead, a copolymer can be determined to have BOCD nature through the methods described in paragraphs [0048]-[0054] and FIG. 2a of WO2022/120321, which description is incorporated herein by reference, especially regarding the description of FIG. 2a and the use of a gas phase chromatography (GPC)-derived plot of comonomer wt % vs. log (MW) to illustrate BOCD when such a plot exhibits positive slope, as quantified through the Comonomer Slope Index values described in the incorporated passages of WO2022/120321. Either or both of the above-noted distinctions (1) and (2) are noted to recognize that some metallocene-catalyzed LLDPE (mLLDPE) can be catalyzed using multiple metallocene catalysts in order to obtain broader Mw/Mn, akin to (or even higher than) that of ZN-LLDPE; but such catalyst systems would then preferably result in BOCD in the mLLDPE, thus even broad Mw/Mn LLDPE can be considered mLLDPE where it exhibits BOCD.

Preferably, all or substantially all (99.9 wt % or more, such as 99.99 wt % or more, or 99.9999 wt % or more) polymer of the polymer composition (before a PEG or PEG masterbatch is provided thereto, as discussed in more detail below) comprises metallocene-catalyzed LLDPE, and particularly metallocene LLDPE produced in a gas phase polymerization reactor. Such polymers often impart superior strength properties such as impact resistance to films made therefrom, often at the cost of being harder to process (and therefore underscoring a greater need for polymer processing aids such as those of the present disclosure).

Density of the polymer may be within the range from 0.905 to 0.945 g/cm³, such as within the range from a low of any one of 0.905, 0.907, 0.908, 0.910, 0.911, 0.912, 0.913, 0.914, or 0.915 g/cm³ to a high of any one of 0.916, 0.917, 0.918, 0.919, 0.920, 0.924, 0.926, 0.930, 0.935, 0.940 or 0.945 g/cm³, with ranges from any foregoing low to any foregoing high contemplated herein (e.g., 0.910 to 0.925 or 0.935 g/cm³, such as 0.912 to 0.925, or 0.915 to 0.918 g/cm³). Alternatively, the polymer may be of higher density (e.g., HDPE), having density within the range from 0.945 g/cm³ to 0.970 g/cm³.

Further, the rheology characteristics of the polymer may influence the preferred PEG-based PPA composition to be employed in the polymer composition to form a finished polymer product. In general, a PPA composition is preferably employed in a polymer having melt index (MI, or I₂, determined per ASTM D1238 at 190° C., 2.16 kg loading) of 5.0 g/10 min or less, preferably 2.5 g/10 min or less, such as within the range from 0.1, 0.2, or 0.5 g/10 min to 1.0, 1.2, 1.5, 2.0, 2.5, 3.0, 4.0, or 5.0 g/10 min (with ranges from any low to any high contemplated). Melt index ratio (MIR) is another polymer characteristic of potential interest in this regard. MIR is herein defined as the ratio of high load melt index (HLMI) (determined per ASTM D1238 at 190° C., 21.6 kg loading) to melt index, or HLMI/MI. Polymers of some embodiments can have MIR generally within the range from 10, 12, or 15 to 19, 20, 21, 22, 25, 27, 30, 35, 40, 45, 50, 60, 65, 70, 75, 80, 85, 90, 95, or 100. In particular embodiments, a PPA composition consisting or consisting essentially of PEG (or a PEG masterbatch, discussed below) is employed for polymers (especially ethylene-based polymers, such as copolymers of ethylene and a C₃ to C₁₂ alpha-olefin) having MIR greater than 20, such as within the range from greater than 20, or from 21, 22, 23, 25, 27, or 30, to a high of 35, 40, 45, 50, 60, 65, 70, 75, 80, 85, 90, 95, or 100. Optionally, MI in such polymers can be less than 1.5 g/10 min, such as 1.0 g/10 min or less (e.g., within the range from 0.1, 0.2, or 0.5 g/10 min to 1.0; or to any one of 1.1, 1.2, 1.3, 1.4, or less than 1.5 g/10 min).

The PEG-based polymer processing aids are discussed in more detail below.

### Polyethylene Glycols

The polymer compositions, as noted, also include polyethylene glycol as a PPA.

It is noted that PEG is a component in some known fluoropolymer-based PPAs (see, e.g., WO2020/146351) and PEG (often referred to as polyethylene oxide or PEO, see below for more details) has been suggested as one among other ingredients such as metal salts of particular acids or alkylsulfate, or silicon-based polymers, or LLDPE additives (made in particular solution process and/or using non-metallocene catalysts) in other PPAs (see, e.g., US2017/0342245; US2015/0175785; CA 2264463 A1). However, the present inventors have found particular lower molecular weight varieties of polyethylene glycol are useful as PPAs, and further that the PEG can be deployed to a polymer composition and in particular to a metallocene-catalyzed LLDPE without other processing aid components, especially, for example, without any one or more of: fluorine-based components; different ethylene polymer components (such as non-gas phase catalyzed polyethylene); silicone-containing components; and/or components such as the aforementioned metal salts of fatty acids. Although, as described herein, there are some potentially useful exceptions to the exclusions of other components: (1) when making a masterbatch of the PEG, a carrier resin (such as LLDPE of types described in more detail below in connection with PEG delivery mechanisms) could be used, so as to enable deployment of the PEG masterbatch during film manufacturing and/or polymer finishing; and/or (2) when deploying the PEG to a polymer composition (e.g., to reactor-grade polymer during finishing and/or to polymer being formed into a film), the PEG can usefully be formed into a composite or blend (e.g., pellets or briquettes) with another additive intended for the polymer product that is a stable solid, which aids substantially in ease of handling and processing the PEG. For example, the PEG can be formed into a pellet or briquette (e.g., through compression molding or the like) with any of the optional additives noted for use in polymer compositions in accordance with the present disclosure (e.g., UV stabilizers, primary and/or secondary anti-oxidants, slip agents, stabilizers), preferably with an optional additive having melting point at 1 atm higher than that of PEG 8K; preferably equal to or greater than 65° C., 70° C., 75° C., 80° C., or 90° C.; more preferably equal to or greater than 100° C., 110° C., 120° C., 130° C., 140° C., or 150° C.; or even equal to or greater than 175° C.; such as within the range from a low of any one of 65, 70, 75, 80, 90, 100, 110, 120, 130, 140, 150, or 175° C. to a high of any one of 125, 150, 175, 200, 250, 300, 350, or 400° C. Such PEG-additive blends are also discussed in more detail below in connection with PEG delivery mechanisms.

As used herein, polyethylene glycol or PEG refers to a polymer expressed as H—(O—CH₂—CH₂) n-OH, where n represents the number of times the O—CH₂—CH₂ (oxyethylene) moiety is repeated; n can range widely, because PEG comes in a wide variety of molecular weights. For instance, n can be about 33 for lower-molecular weight polyethylene glycols (˜1500 g/mol), ranging up to about 227 for higher molecular weight polyethylene glycols (˜10,000 g/mol) such as about 454 for ˜20,000 g/mol molecular-weight PEG; and 908 for ˜40,000 molecular-weight PEG; and even higher for higher-molecular-weight PEG varieties.

It is also noted that PEG can equivalently be referred to as polyethylene oxide (PEO) or polyoxyethylene (POE). Sometimes in industry parlance, PEG is the nomenclature used for relatively lower molecular weight varieties (e.g., molecular weight 20,000 g/mol or less), while polyethylene oxide or PEO is used for higher-molecular-weight varieties (e.g., above 20,000 g/mol). However, for purposes of the present application, references to polyethylene glycol or PEG should not, alone, be taken to imply a particular molecular weight range, except where a molecular weight range is explicitly stated. That is, the present application may use the terms polyethylene glycol or PEG to refer to a polymer having structure H—(O—CH₂—CH₂) n-OH with n such that the polymer's molecular weight is less than 20,000 g/mol, and it may also use the terms polyethylene glycol or PEG to refer to such a polymer with n such that the polymer's molecular weight is greater than 20,000 g/mol, such as within the range from 20,000 to 40,000 g/mol.

PEG “molecular weight” as used herein refers to weight-average molecular weight (Mw) as determined by gel permeation chromatography (GPC), and PEG “molecular weight distribution” or MWD refers to the ratio of Mw to number-average molecular weight (Mn), i.e., Mw/Mn. PEG compositions for use in PP As may advantageously have narrow MWD, such as within the range from a low of any one of about 1.0, 1.1, 1.2, 1.3, 1.4, or 1.5 to a high of any one of about 1.1, 1.2, 1.3, 1.4, 1.5, 1.6, 1.7, 1.8, 1.9, 2.0, 2.5, or 3.0, with ranges from any foregoing low end to any foregoing high end contemplated, provided the high end is greater than the low end (e.g., 1.0 to 2.0, or 1.0 to 1.5, such as 1.0 to 1.2 or even 1.0 to 1.1). For instance, PEG compositions having MWD of about 1 to 1.1 or 1.2 may be particularly useful. However, obtaining such a uniform length of polymer chains (i.e., narrow MWD) can be expensive; thus, commercially available PEG compositions might have broader MWD values (e.g., ranging from 1 to 3, 4, 5, or even greater). Such PEG compositions are therefore also within the scope of the invention. These PEG compositions can still suitably be employed as PP As, potentially (but not necessarily) compensating by increasing the PEG loading for such broader-MWD PEGs (e.g., 700-1400 ppm, as compared to loadings as low as 400-700 ppm for narrower-MWD PEGs). PEG-based PPA loading is discussed in more detail below.

In embodiments employing narrow MWD PEG, Mw values for PEG will commonly be in relatively close agreement with Mn (e.g., within 10%); regardless, however, where differences between the two (Mw and Mn) exist, Mw should control as the preferred “molecular weight” measurement for purposes of the present disclosure. It is also noted that many commercial PEG compounds include a nominal molecular weight (e.g., “PEG 3K” or “PEG 10K” indicating nominal 3,000 g/mol and 10,000 g/mol molecular weights, respectively). Again, Mw of the PEG should control over any contrary nominal indicator.

Polyethylene glycols suitable for use in PEG-based PPAs herein generally can include PEG of a variety of molecular weights, potentially including PEG having Mw ranging from as low as 500 g/mol to as high as 200,000 g/mol, such as from a low of any one of 500, 600, 700, 800, 900, 1000, 3000, 5000, 7000, or 7500 g/mol to a high of 40000, 50000, 60000, 75000, 80000, 90000, 100000, 125000, 150000, 175000, or 200000 g/mol, with ranges from any low end to any high end contemplated.

In certain embodiments, however, particularly preferred PEGs are those having molecular weight less than 40,000 g/mol; such as within the range from a low of any one of 500, 600, 700, 800, 900, 1000, 1500, 2000, 2500, 3000, 3500, 4000, 4500, 5000, 5500, 6000, 7000, 8000, 8500, 9000, 9500, 10000, 12500, and 15000 g/mol to a high of any one of 7000, 7500, 8000, 8500, 9000, 9500, 10000, 10500, 11000, 11500, 12000, 12500, 15000, 20000, 22000, 25000, 30000, 35000, 39000, and 39500 g/mol, provided the high end is greater than the low end, and with ranges from any foregoing low end to any foregoing high end generally contemplated (e.g., 1,500 to 35,000 g/mol, or 5,000 to 20,000 g/mol, such as 5,000 to 12,000 g/mol or 6,000 to 12,000 g/mol). Particular higher or lower sub-ranges may also be suitable (e.g., PEG having Mw of 1,500 to 5,500 g/mol; or PEG having Mw of 5,000 to 12,000 g/mol; or PEG having Mw of 10,000 to 20,000 g/mol; or PEG having Mw of 15,000 to 25,000 g/mol; or PEG having Mw of 25,000 to 35,000 g/mol).

Further, it is also contemplated that blends of multiple of the aforementioned PEG compounds could form a suitable PPA. For instance, a PEG-based PPA can comprise at least 90 wt %, preferably at least 99 wt %, of a blend of two or more polyethylene glycols, for instance any two or more of: a first PEG having molecular weight within the range from 3,000 to 7,000 g/mol; a second PEG having molecular weight within the range from 5,000 to 12,000 g/mol; a third PEG having molecular weight within the range from 10,000 to 20,000 g/mol; and a fourth PEG having molecular weight within the range from 20,000 to 40,000 g/mol, provided that each of the first, second, third, and fourth PEG of such blends have different molecular weights from the other polyethylene glycol(s) of those blends. And, in some embodiments, a higher-molecular weight PEG could be included in such blend (e.g., one or more PEGs having molecular weight greater than 40,000 g/mol).

However, as noted, it is contemplated that PEG-based PPA compositions of many embodiments as described herein do not include polyethylene glycol (or polyethylene oxide) having molecular weight greater than 40,000 g/mol. That is, it is preferred that all or substantially all polyethylene glycol of the polymer compositions has molecular weight less than 40,000 g/mol; such as less than 35,000 g/mol, or less than 33,000 g/mol, or less than 22,500 g/mol, or less than 20,000 g/mol, or less than 12,000 g/mol, such as less than 10,000 g/mol. In this context, “substantially all” means that minor amounts (50 ppm or less, more preferably 10 ppm or less, such as 1 ppm or less) of higher-molecular weight PEG could be included while not losing the effect of including predominantly the lower-molecular-weight PEGs described herein. Put equivalently, the PEG having molecular weight greater than 40,000 g/mol is absent or substantially absent from the polymer compositions. It is believed that the focus on lower molecular-weight PEG enables generally lower loadings of the PEG-based PPA to achieve the desired elimination of melt fractures across most grades of polymer that might experience melt fracture when formed into blown films. Similarly, lower molecular-weight PEG is believed to diffuse faster to the surface of polymer material being extruded in, e.g., blown film processes, as compared to higher molecular weight varieties of PEG; therefore, the lower molecular-weight PEG varieties will typically lead to faster elimination of melt fracture in blown films (and therefore lower off-spec production).

Commercially available examples of suitable polyethylene glycols, especially those of lower molecular weight, include Pluriol® E 1500; Pluriol® E 3400; Pluriol® E 4000; Pluriol® E 6000; Pluriol® E 8000; and Pluriol® E 9000 polyethylene glycols available from BASF (where the numbers represent nominal molecular weights of the PEG); and also include Carbowax™ 8000, Carbowax™ Sentry™ 8000 NF EP available from Dow.

### Measuring Moments of Molecular Weight

Unless otherwise indicated, the distribution and the moments of molecular weight for PEG compounds are determined by using Agilent 1260 Infinity II Multi-Detector GPC/SEC System equipped with multiple in-series connected detectors including a differential refractive index (DRI) detector, a viscometer detector, a two-angle light scattering (LS) detector and a UV diode array detector. Two Agilent PLgel 5-μm Mixed-C columns plus a guard column are used to provide polymer separation. THF solvent from Sigma-Aldrich or equivalent with 250 ppm of antioxidant butylated hydroxytoluene (BHT) is used as the mobile phase. The nominal flow rate is 1.0 ml/min and the nominal injection volume is 25 μL. The whole system including columns, detectors and tubings operates at 40° C. The column calibration was performed by using twenty-three polystyrene narrow standards ranging from 200 to 4,000,000 g/mole.

The Agilent Multi-Detector GPC Data Analysis Software is used to process data from any combination of DRI, light scattering and viscometer detectors to obtain information about polymer properties. Here, the light scattering MW is calculated by combining the concentration measured by DRI and the Rayleigh ratio measured by LS in each elution volume slice plus the detector calibration constants and polymer parameters such as refractive index increment (dn/dc). For the poly(ethylene glycol) samples used in this disclosure, the dn/dc is determined to be around 0.07 ml/g in THF solvent.

For determination of molecular weight (Mw, Mn, and/or Mz) of polymers and in particular of ethylene homo- or copolymers, one should use the method described in paragraphs [0044]-[0051] of PCT Publication WO 2019/246069, which description is incorporated by reference herein. Unless specifically mentioned otherwise, all the molecular weight moments used or mentioned in the present disclosure are determined according to the conventional molecular weight (IR molecular weight) determination methods (e.g., as referenced in Paragraphs [0044]-[0045] of the just-noted publication), noting that for the equation in such Paragraph [0044], a=0.695 and K=0.000579 (1-0.75 Wt) are used, where Wt is the weight fraction for comonomer

### Amounts of PEG and PEG Molecular Weights

The polyethylene glycol can be deployed in the polymer composition in amounts of at least 200 ppm, such as at least 250 ppm, at least 300 ppm, at least 400 ppm, at least 500 ppm, or at least 600 ppm. For instance, it can be deployed in an amount within a range from a low of any one of 200, 250, 300, 350, 400, 450, 500, 550, 600, 650, 700, 750, 800, 900, 950, 1000, 1100, 1200, 1250, and 1500 ppm to a high of any one of 400, 500, 600, 700, 800, 900, 1000, 1100, 1200, 1300, 1400, 1500, 1600, 1700, 1800, 1900, 2000, 2500, 3000, 3500, 4000, 4500, 5000, 7500, 10000, 12500, and 15000 ppm, with ranges from any foregoing low to any foregoing high contemplated, provided the high end is greater than the low end (e.g., 300 to 15,000 ppm, such as 300 to 2,000 ppm; or 500 to 1500 ppm, such as 600 to 1300 ppm, or 700 to 1200 ppm). The ppm values can apply for either polyethylene glycol included in a polymer composition; or to PEG-based PPA composition included in the polymer composition, in various embodiments. Further, the ppm values recited herein for polyethylene glycol (or PEG-based PPA composition), as well as any other additives described herein, are all based on mass of the polymer composition (i.e., inclusive of polymer plus PPA, as well as any and all other additives in the polymer composition), unless otherwise specifically noted. Amounts of PPA in a polymer composition can most readily be determined using mass balance principles (e.g., PPA amount is determined as mass of PPA added to a polymer composition, divided by (mass of PPA plus mass of polymer plus mass of any other additives blended together to form the polymer composition)). NMR analysis could be used to determine the PPA content of an already-mixed polymer composition (e.g., polymer pellet(s) comprising the polymer and PPA), but where there is a discrepancy between the two methods (mass balance and NMR), the mass balance method should be used.

Furthermore, the present inventors have found surprisingly that PEG molecular weight can affect optimal loading amounts. Specifically, higher-molecular weight PEG eliminates melt fracture faster at lower loading as compared to lower-molecular weight PEG; and at the same time, higher loading of higher-molecular weight PEG can in fact lead to slower melt fraction elimination in films made using the polymer composition comprising the PEG-based PPA. On the other hand, significantly lower-molecular weight PEG variants can require higher loadings, while lower loadings of these PEG varieties can take excessively long to eliminate melt fracture (or fail to eliminate it entirely). The cutoff between these opposing trends appears to take place somewhere in the range of 6,500-10,000 g/mol molecular weight, such as 7,500 to 9,500 g/mol; with such molecular weight region representing a transition area where neither trend is excessively pronounced. Thus, PEG having Mw less than 7,500 g/mol is in general best employed at higher loading (e.g., 1000, 1100, or 1200 ppm to 2000 or more ppm), while PEG having Mw greater than 10,000 g/mol is better employed at moderate or low loading (e.g., 200 to 500, 600, 700, 800, 900, 1000, 1100, or 1200 ppm, on basis of mass of the polymer). The picture is somewhat further complicated, however, so the solution is not necessarily as simple as preferentially selecting higher molecular-weight PEG. In particular, as described herein, certain grades of polymers can require higher loading of PEG (regardless of molecular weight) as polymer rheology also affects performance of PEG in eliminating melt fracture from blown films made from the polymer. Therefore, employing higher molecular-weight PEG can lead to the pitfall of grade-specific loading variations, where accidentally loading too much PEG can detrimentally impact performance in some cases while improving it in others.

Moreover, as noted, the preferred PEG loading ranges may further need to be tailored based upon the properties of the polymer to which the PEG-based PPA composition is deployed, and in particular the rheological properties of the polymer. For instance, a polymer (e.g., a metallocene catalyzed linear low density ethylene copolymer) having lower MI and/or higher MIR may call for a higher loading of PEG. For instance, where MI is less than 0.45 g/10 min (190° C., 2.18 kg) (and optionally further where MIR is greater than 30), loadings of 700 ppm or higher, even up to 1000 or 1100 ppm may be required.

Given the complexity of encountering potential diminishing returns in melt fracture elimination at higher PEG loadings for higher-Mw PEG varieties in some polymers, while requiring higher PEG loadings for other polymers (e.g., of the low MI variety), the present compositions and methods emphasize simplicity, in particular by targeting a PEG having Mw in the middle range of the above-observed phenomenon (e.g., Mw within the range from 6500, 7000 or 7500 g/mol to 10,000 g/mol, such as from 6500 or 7500 g/mol to 9000 or 9500 g/mol). This enables a robust tailoring of PEG loading to the polymer, while at the same time avoiding the concern of substantial loss in performance when moving to higher loadings, as is sometimes observed with higher molecular-weight PEG.

### PEG Delivery Mechanisms

Relatively lower-molecular weight PEG (e.g., Mw of 40,000 g/mol or less, and particularly PEG having Mw less than 10,000 g/mol) can present some handling challenges due to lower melting and softening points. In addition, lower molecular weight PEG has a substantially lower melting temperature than many polymers (e.g., polyethylene homopolymers or copolymers), and therefore can start beading up during attempts to mix this ingredient with such polymers having higher melting point than PEG. This phenomenon can affect proper mixing. Furthermore, as a generally hydrophilic compound, PEG's incorporation into typically more hydrophobic polymer compositions can present some challenges, requiring close examination of suitable molecular weight ranges, amounts, and methods of incorporation of PEG-based PPAs into a polymer composition.

The present inventors have identified suitable processing conditions and methods that individually or collectively can overcome many of the challenges of incorporating PEG into a polymer composition.

For example, the PEG PPA can be deployed to a polymer composition as a masterbatch. Such PEG masterbatches generally include PEG and a carrier resin. When PEG is provided in a masterbatch, the masterbatch is provided to the polymer composition in an amount such that the final loading of PEG in the polymer composition is in accordance with the description herein. Thus, a PEG masterbatch having 4 wt % PEG loading can be deployed at 25,000 ppm (2.5 wt %) in a polymer composition (on basis of total mass of the polymer composition, including the masterbatch) to target 1000 ppm loading of PEG in the polymer composition. The ordinarily skilled artisan will readily be able to recognize PEG masterbatch loading required to achieve desired overall PEG loading in the polymer composition in accordance with the description above of preferred PEG loadings.

The carrier resin can be any suitable olefinic homopolymers or copolymer, although preferred carrier resins will be generally compatible with the polymers targeted in a given production campaign. That is, for a production campaign of ethylene-based polymers, an ethylene-based carrier resin (e.g., having at least 50 wt % units derived from ethylene) is preferred; while for a production campaign of propylene-based copolymers, such as propylene-ethylene elastomers, a propylene-ethylene copolymer carrier resin, or other propylene-based carrier resin (having at least 50 wt % units derived from propylene) would be preferred. More particularly, a PEG masterbatch for use in LLDPE would employ a LLDPE carrier resin (although it is noted that a Ziegler-Natta catalyzed LLDPE carrier resin may be used for a PEG masterbatch intended for deployment in a polymer composition including mLLDPE, and vice-versa).

Moreover, the carrier resin preferably has melt index (MI, measured at 190° C. and 2.16 kg loading) of 0.8 g/10 min or greater, such as 1.0 g/10 min or greater, or 1.5 g/10 min or greater. In some instances, however, too great a melt index may detrimentally impact final polymer composition properties. Furthermore, excessively high MI in the carrier resin can cause immiscibility with the polymer composition to which the masterbatch is being added. Thus, the carrier resin may have MI within the range from 0.8 or 1.0 or 1.5 g/10 min to 2.5, 3.0, 3.5, 4.0, 4.5, 5.0, 7.5, or 10.0 g/10 min (with ranges from any low end to any high end contemplated); and/or Mw/Mn (ratio of weight-average molecular weight to number-average molecular weight, otherwise referred to as polydispersity or molecular weight distribution) greater than 3.0, preferably greater than or equal to 3.5, 4.0, 4.2, 4.3, 4.4, or 4.5. Particular examples include polyethylene (and in particular LLDPE, either ZN-catalyzed or metallocene-catalyzed) having such MI and/or Mw/Mn. Such LLDPE is preferably polymerized in a gas phase polymerization reactor, and can be in accordance with the description of LLDPE suitable for the polymer composition, as described above. Examples include mLLDPE such as Exceed™ performance polyethylene from ExxonMobil, such as Exceed 1018™ or Exceed 2018™ metallocene polyethylene resins; or Marlex™ D139 or D143 from Chevron Phillips Chemical. Other examples include Ziegler-Natta catalyzed LLDPE (ZN-LLDPE), such as copolymers of ethylene and 1-butene, 1-hexene, and/or 1-octene, as catalyzed by Ziegler Natta catalysts (such polymers, as noted, typically having broader molecular weight distribution, Mw/Mn, as compared to metallocene-catalyzed counterparts). Examples include LL1001 or LL1002 LLDPE available from ExxonMobil, MARLEX™ 7109 or 7120 LLDPE available from Chevron Phillips Chemical, Dowlex GM 8480G available from Dow Chemical. Yet further suitable examples of polyethylene carrier resin include low density polyethylene (LDPE) as may be produced from free radical polymerization, particularly a high pressure polymerization process.

Polypropylene-based carrier resins (including homopolypropylene or hPP) are also suitable, especially where the PEG processing aid is to be deployed in conjunction with a polypropylene resin.

PEG loading in the masterbatch can be adjusted as needed, and the ordinarily skilled artisan will readily recognize the inverse relationship between PEG loading in the PEG masterbatch, and amount of masterbatch to be deployed in a polymer composition in order to achieve target PEG loading in the polymer composition (e.g., as the PEG masterbatch comprises more PEG, correspondingly less PEG masterbatch need be loaded into the polymer composition). For sake of illustration, example loadings of PEG in PEG masterbatch include PEG within the range from a low of 1, 2, 3, 4, or 5 wt % to a high of 5, 6, 7, 8, 9, 10, 20, 25, 30, 35, 40, 45, 50, or 60 wt %, with ranges from any foregoing low end to any foregoing high end contemplated (provided the high end is greater than the low end). However, it may be preferred to keep PEG loading in the masterbatch relatively lower (e.g., within the 1-10 wt % range, such as from a low of any one of 1, 1.5, 2, or 2.5 wt % to a high of any one of 3, 3.5, 4, 4.5, 5, 7.5, or 10 wt %, with ranges from any low end to any high end contemplated), particularly for PEG having Mw within the range from 7500 to less than 10,000 g/mol, such as 6,500 to 9,500 g/mol. Thus, a PEG masterbatch comprising 4 wt % PEG (on basis of mass of masterbatch) may be deployed at 2.5 wt % loading (25000 ppm), on the basis of mass of the polymer composition, to provide 1000 ppm PEG loading the polymer composition; and deployed at 5.0 wt % loading (50000 ppm), on the basis of mass of the polymer composition, to provide 2000 ppm PEG loading in the polymer composition. Such relatively low PEG loadings in masterbatch can help ensure an adequate amount of material for ease of handling, while not delivering excessive amounts of PEG to the polymer composition (e.g., finished polymer pellets or polymeric article such as film), which could negatively impact toughness properties of polymeric articles.

Finally, as discussed elsewhere herein, additional additives and/or a PPA blend partner may be included in the polymer composition. It is contemplated that such additives and/or PPA blend partner may be added to the polymer composition separately from a PEG masterbatch, or as part of the PEG masterbatch. Thus, for example, a PEG masterbatch can comprise, or preferably can consist or consist essentially of: (i) PEG (e.g., having Mw 6,500 to 9,500 g/mol, or other Mw in accordance with description herein); (ii) carrier resin (e.g., LLDPE or other carrier resin as described above); and (iii) optionally, one or more non-PPA additives. A non-PPA additive is an additive included in a polymer composition for reasons other than prevention of melt fracture in film formation, as would be understood by the ordinarily skilled artisan. As with all PPA and polymer compositions discussed herein, such PEG masterbatch is free or substantially free of fluorine and/or fluorine-containing compounds. Examples of suitable non-PPA additives are discussed in more detail below.

Also provided herein are alternatives to a PEG masterbatch, which can be deployed instead of or in addition to a PEG masterbatch: specifically, PEG composites. A PEG composite can be a PEG-additive blend or composite (in this context, blend and composite are used synonymously) or a PEG-polymer composite. A PEG-additive composite is a solid (e.g., granules, briquettes, pellets, or the like) comprising (or consisting of or consisting essentially of) PEG and one or more non-PPA additives. Each of the one or more non-PPA additives can have a melting point at 1 atm higher than that of PEG 8K (e.g., higher than 55° C.). Preferably, the non-PPA additive(s) of the composite each have melting point equal to or greater than 65° C., 70° C., 75° C., 80° C., or 90° C.; more preferably equal to or greater than 100° C., 110° C., 120° C., 130° C., 140° C., or 150° C.; or even equal to or greater than 175° C.; such as within the range from a low of any one of 65, 70, 75, 80, 90, 100, 110, 120, 130, 140, 150, or 175° C. to a high of any one of 125, 150, 175, 200, 250, 300, 350, or 400° C. Alternatively, the PEG composite can be a composite formed of PEG and a polymer (said polymer having melting points within any of the foregoing ranges recited for additives); although a PEG-polymer composite is distinguished from a masterbatch in the method of formation. The composites (PEG-additive or PEG-polymer) may be formed as compacted solids (compression molded, briquetted, or otherwise compacted together), and preferably with a weight ratio of PEG: additive(s) (or PEG:polymer(s)) of about 50:50 (such that the composite comprises 47, 48, 49, or 50 wt % PEG, with the balance additive(s), for PEG-additive composites; or with the balance polymer(s), for PEG-polymer composites). More generally, the composite can comprise PEG within a range from a low of any one of 30, 35, 40, 45, 50, or 55 wt % to a high of any one of 35, 40, 45, 50, 55, 60, 65, or 70 wt %, with ranges from any foregoing low end to any high end contemplated, provided the high end is greater than the low end; with the balance being the additive(s) or polymer(s) of the composite.

In various embodiments, a PEG composite can consist essentially of PEG and one non-PPA additive; or consist essentially of PEG and a polymer solid.

The non-PPA additives suitable for inclusion in the masterbatch and/or the PEG composite can be one or more of the following: UV stabilizers, slip agents, primary antioxidants, secondary antioxidants, antiblock agents; provided that, in the case of the PEG composite, such additive(s) have suitable melting point in accordance with the above description. Other potential non-PPA additives are also mentioned below.

The polymer solids suitable for making PEG-polymer composites advantageously include any of the LLDPE or LDPE already discussed in the context of polymer compositions or as carrier resins of PEG masterbatches, subject to the further desired melting point features just described.

### Non-PPA Additives

Non-PPA additives suitable for polymer compositions in accordance with the present disclosure are preferably those free of or substantially free of fluorine and/or fluorine-containing compounds. And, as noted, they are not added for the purpose of eliminating melt fracture in extruded and/or blown films made using the polymer composition.

Non-PPA additives can include UV stabilizers (sometimes referred to as light stabilizers), such as hindered amine light stabilizers (HALS) or UV absorbers (e.g., triazines, hydroxyphenyl triazines, benzotriazoles, hydroxyphenyl benzotriazoles, benzophenones, hydroxy benzophenones, cyanoacrylates, oxanilides, organo-nickel compounds). Carbon black (known as a pigmentation agent) can also act as a UV absorber.

Various slip agents (e.g., amides such as oleamide, erucamide, stearamide, behenamide; secondary fatty acid amides) are also examples of non-PPA additives, as are various antiblock agents. According to various embodiments, it may be advantageous to employ antiblock and/or slip agents with the PEG (including, e.g., in a PEG composite or masterbatch). In particular as regards antiblock and slip agents these may provide a potential advantage of quicker melt fraction elimination when employed with the PEG-based PPA. Examples of antiblock agents are well known in the art, and include mineral type anti-block agents such as talc, crystalline and amorphous (fumed) silica, nepheline syenite, diatomaceous earth, clay (e.g., kaolin clay), zeolites, or various other anti-block minerals. Particular examples include the Optibloc™ agents available from Mineral Technologies. Examples of slip agents for polyolefins include amides such as erucamide, stearamide, behenamide, oleyl palmitamide, stearyl erucamide, ethylene-bis-stearamide, ethylene-bis-oleamide, and combinations thereof; as well as other primary fatty amides like oleamide; and further include certain types of secondary (bis) fatty amides and/or secondary fatty acid amides such as oleyl palmitamide, stearyl erucamide, ethylene-bis-stearamide, ethylene-bis-oleamide. Antiblock agent loading in the polymer composition is often around 500 to 6000 ppm, such as 1000 to 5000 ppm; slip agent loading in the polymer composition is typically 200 to 1000, 2000, or 3000 ppm. It will be appreciated that where antiblock and/or slip agents are included in a masterbatch (e.g., a PEG masterbatch), then loading in the masterbatch and amount of masterbatch provided should be adjusted to target these loadings in the resultant polymer composition to which the masterbatch is provided (for example, to achieve 1000 ppm of antiblock agent in the resultant polymer composition, one can deploy 2.5 wt % (on basis of masterbatch+polymer composition) of a masterbatch having 4 wt % antiblock agent loading in the masterbatch).

Primary and secondary antioxidants are further examples of non-PPA additives. These compounds are also sometimes referred to as thermal stabilizers. The “primary” antioxidants typically act as free-radical scavengers; and the “secondary” antioxidants typically act as peroxide scavengers, sometimes referred to as hydroperoxide decomposers. Hindered phenols, such as butylated hydroxytoluene (BHT), Vitamin E (alpha-tocopherol) are common examples of primary antioxidants. Further examples include di-tert-butylphenyl compounds. The IRGANOX™ product line available from BASF are typical examples of suitable hindered phenol primary antioxidants (Irganox™ 245, Irganox™ 1010, Irganox™ 1076, Irganox™ MD 1024, Irganox™ 3114, Irganox™ 1098, Irganox™ 3052, Cyanox™ 2246, ADK STAB AO-80). Other radical scavengers used as primary antioxidants include hydroxylamines such as oxidized bis(hydrogenated tallow alkyl)amines, an example being Irgastab™ FS042 from BASF. Phosphite antioxidants are common examples of secondary antioxidants (peroxide scavengers), and typical examples include monophosphites, diphosphites, and mixed phosphites. Examples of suitable monophosphites include: tris nonyl phenyl phosphite (TNPP) and tris (2,4 di-tert-butylphenyl)phosphite (tradename IRGAFOS™ 168, available from BASF; or tradename Alkanox™ 240, available from SI Group). Examples of diphosphites (containing at least two phosphorus atoms per phosphite molecule) and diphosphonites include: distearyl pentaerythritol diphosphite, diisodecyl pentaerythritol diphosphite, tetrakis(2,4-di-tert-butylphenyl)-4,4-biphenyldiphosphonite (commonly referred to as PEPQ powder), bis (2,4 di-tert-butylphenyl) pentaerythritol diphosphite (sold under the trade name ULTRANOX® 626, y SI Group), bis(2,6-di-tert-butyl-4-methylphenyl) pentaerythritol diphosphite; bisisodecyloxy-pentaerythritol diphosphite, bis(2,4-di-tert-butyl-6-methylphenyl) pentaerythritol diphosphite, bis(2,4,6-tri-tert-butylphenyl) pentaerythritol diphosphite, and bis(2,4-dicumylphenyl) pentaerythritol diphosphite (sold under the trade name DOVERPHOS™ S9228 by Dover Chemicals Corporation, optionally with 1% triisopropanol amine (as DOVERPHOS™ S9228-T)). Proprietary phosphite antioxidants are also available and known, such as Weston™ 705 from SI Group, comprising proprietary liquid phosphite(s). Primary and/or secondary antioxidants can be particularly useful for inclusion in a masterbatch or PEG composite since these compounds are often included to protect polymers such as polyethylene from free radical decomposition, thus they may be particularly useful for inclusion in any masterbatch having a carrier resin such as a polyethylene (e.g., LDPE or LLDPE) carrier resin. Primary antioxidant loading in the resultant polymer composition (after delivery of any masterbatch containing primary antioxidant) is preferably within the range from a low of 200, 300, or 400 ppm to a high of 600, 700, 800, 900, 1000, 1250, 1500, 1750, or 2000 ppm (with ranges from any foregoing low to any foregoing high contemplated, such as 200 to 2000 ppm or 300 to 800 ppm). Secondary antioxidant loading in the resultant polymer composition (after delivery of any masterbatch and/or composite containing secondary antioxidant) is preferably within the range from a low of 200, 300, 400, 500, 600, 700, or 800 ppm to a high of 900, 1000, 1100, 1200, 1300, 1400, 1500, 1750, 2000, 2250, or 2500 ppm (with ranges from any foregoing low to any foregoing high contemplated, such as 200 to 2000 ppm or 800 to 1300 ppm).

Other non-PPA additives can include, for example one or more of the following: acid scavengers (metal stearates, or Al—Mg hydrocycarbonates such as hydrotalcite, zinc oxide, magnesium oxide); nucleating agents (talc, sodium benzoate, certain phosphates such as Irgastab™ NA-11 from BASF); clarifiers (DMDBS such as Millad™ 3988 or MDBS such as Millad™ 3940, both from Milliken); anti-fog agents; fillers; anti-cling additives; tackifiers, such as polybutenes, terpene resins, aliphatic and aromatic hydrocarbon resins, alkali metal and glycerol stearates, and hydrogenated rosins; heat stabilizers; release agents; anti-static agents; pigments; colorants; dyes; waxes; talc; mixtures thereof, and the like.

With any of the foregoing additives, it is useful to note that the same of any given type of additive may be present in both the base polymer composition (before addition of any PEG masterbatch or PEG composite) and in the PEG masterbatch and/or PEG composite. The guidance above is provided for final loading of additives in the polymer composition after inclusion of the masterbatch or composite. The ordinarily skilled artisan with the benefit of this disclosure will readily be able to determine preferred additive loading in a masterbatch or composite in combination with amount of masterbatch to deliver to the polymer composition in order to obtain the resultant target loading in the polymer composition. For example, to achieve final antioxidant (primary or secondary) loading of 400-500 ppm, one could recognize that, e.g., 400 ppm of the antioxidant could be present in the polymer composition, in which case addition of 2.5 wt % masterbatch to the polymer composition (on basis of polymer composition+masterbatch) can maintain antioxidant target when the antioxidant is present in the masterbatch at 0 to 0.4 wt % (0 to 4000 ppm). PPA additives other than PEG advantageously need not be employed, and thus the PEG masterbatches, PEG composites, polymer compositions, and/or polymer products of the present disclosure advantageously are free or substantially free of fluorine and/or fluorine-containing compounds; silicone and silicone-containing compounds (such as polysiloxanes); polycaprolactones; and the like.

### Methods of Introducing PEG Masterbatches and PEG Composites to Polymer Compositions

Methods in accordance with various embodiments generally include adding PEG to a polymer composition to form a polymer product. The addition of PEG can be to polymer granules (e.g., reactor-grade polymer exiting a polymerization reactor system but upstream of finishing processes such as compound extrusion and/or pelletization), and the polymer product formed thereby is in the form of polymer pellets with PEG additive. In such instances, the polymer composition can be taken as the polymer granules, and the polymer product as the pellets. In other cases, the PEG can be added to a polymer composition (such as finished pellets) being fed to a film or other polymeric article extrusion process, to form a polymer product in the form of a polymeric film or other article (e.g., a blown film). In such instances, the polymer composition is taken as the polymer pellets being fed to the film extrusion process (or other article formation process), and the polymer product is taken as the polymeric film (or other article).

Furthermore, the method of PEG delivery in any of the just-noted circumstances is preferably either: (1) introduction of a PEG composite (as described above) to the polymer composition or (2) introduction of a PEG masterbatch (also as described above) to the polymer composition. A PEG composite or PEG masterbatch can be provided to a polymer composition of either type (pre-finished, reactor grade polymer composition so as to form polymer pellets; or polymer pellet composition, so as to form a polymeric article).

Providing the PEG can be carried out in batch (e.g., melt mixing in a mixing tank, blender, or the like), but it is preferably carried out on a continuous basis during at least a portion of a continuous extrusion process. For instance, methods can include (a) continuously extruding a polymer composition through an extruder to form polymer product; and (b) during at least a portion of the extruding (preferably, but not necessarily, during the entirety of the extruding), continually feeding a PEG composite to the extruder so that the PEG composite and polymer composition are coextruded through the extruder at conditions sufficient to melt blend the PEG composite and the polymer composition. The PEG composite comprises solid particles of PEG and one or more non-PPA additives, as in the description of PEG composites above (e.g., PEG having Mw less than 10,000 and one or more non-PPA additives having melting point at 1 atm greater than that of the PEG). In such processes, the polymer composition can be polymer granules or other reactor-grade polymer, such that the continuous extrusion is compounding extrusion; and the polymer product formed is in the form of finished polymer pellets. Alternatively, the polymer composition can be in the form of already-finished polymer pellets; the extrusion is part of a polymeric filmmaking process (or part of a process for producing another polymeric article); and the polymer product is a polymeric film such as a blown film, or other polymeric article.

In the above methods, PEG masterbatch may be substituted for the PEG composite, and the process carried out in the same manner.

In some instances, a polymer composition may be utilized in extrusion for filmmaking, e.g., blown filmmaking, under conditions that may require feeding PEG during some or all of the extrusion. This can be the case even when the polymer composition being used in the filmmaking extrusion process already has PEG or other processing aid, e.g., where processing conditions are such that melt fracture develops after a substantial portion of film production without melt fracture. In particular, the present inventors have found that harsh film processing conditions can lead to re-development of melt fracture, even in PEG-containing polymer, after sometimes substantial periods of time producing otherwise melt fracture-free film (e.g., after 5, 6, or more hours of producing melt fracture-free film). The phenomenon is believed to be tied to a combination of the die factor (a function of polymer throughput through a die and cross-sectional size of the die, such as circumference of the die in a blown film extrusion process) and the die gap (the thickness of the ring or other aperture through which the polymer is extruded), and in particular is thought to vary proportionally with [die factor]/[die gap] ², where die factor may be expressed as lb/(hr*in die), where in die is the circumference of the die (or greatest cross-sectional width); and die gap is in mil. Thus, an “Extrusion Processing Factor” can be defined, where EPF=100×[die factor]/[die gap] 2, with a larger value of EPF being indicative of more harsh processing conditions. When framed in these units, one or more of the following can indicate the need for additional PEG (e.g., even where PEG is already present in a polymer composition) during filmmaking extrusion such as blown film extrusion: die gap of 70 mil or less, such as 60 mil or less, or 50 mil or less; die factor of 10 or more, such as 15 or greater, or 20 or greater; and EPF of 0.4 or greater. It will be appreciated that, for a smaller die gap, die factor need not necessarily be large to still encounter harsh processing conditions that may merit added PPA delivery.

Thus, the present disclosure also provides processes for making polymeric film, the processes including: (a) for a first time interval, continuously extruding a polymer composition through an extruder at extrusion conditions to form the polymeric film; (b) at a first time endpoint during the continuous extrusion, developing one or more melt fractures in the polymeric film; (c) in response to developing the one or more melt fractures in the film, continuously feeding a PPA masterbatch to the extruder during a second time interval after the first time interval; and (d) continuously obtaining the polymeric film at least during the second time interval (and optionally during both the first and second time intervals). As with other polymer compositions described herein, the polymeric film is free or substantially free of fluorine and/or fluorine-containing compounds, and likewise can be free or substantially free of other PPA compounds besides the PEG (e.g., free of silicone/silicone-containing compounds, and/or free or substantially free of caprolactone-containing compounds, and/or free of higher molecular weight PEG such as PEG having Mw 10,000 g/mol or higher). Any polymeric film obtained during the first time interval may have 500-1300 ppm PEG, or any other suitable PEG loading as described above for a polymer composition; polymeric film obtained during the second time interval will have more PEG than that obtained during the first time interval.

However, it is preferred not to add excessive amounts of PEG to avoid or eliminate melt fracture. It is found that excessive levels of PEG can detrimentally impact certain toughness properties of a polymeric film product, in particular dart impact (e.g., as measured by Dart A phenolic, in g/mil). Therefore, care should be taken in delivering an appropriate amount of PEG to eliminate/prevent melt fracture while minimizing detrimental impact to film properties. It is found that PEG loading in the polymeric film or other article (especially that obtained during the second time interval in connection with methods just described) is preferably less than 3000 ppm, more preferably 2500 ppm or less, such as within the range from 800 to 2500 ppm. Thus, when PEG loading begins within the range from, e.g., 500 to 1300 ppm (e.g., because of PEG already present in the polymer before film extrusion), any PEG added during the filmmaking extrusion (e.g., per methods just described) should be added in amounts such that the polymeric film comprises less than 3000 ppm of PEG, preferably 2500 ppm or less, such as within the range from 800, 900, 1000, 1250, or 1500 ppm to 2000, 2200, 2250, or 2500 ppm (with ranges from any low end to any high end contemplated).

The above methods and any other methods of mixing the PEG (or PEG-based PPA) with polymer to form a polymer composition as described herein, also include adequately mixing the PEG into the polymer. The present inventors have surprisingly found that not all methods of mixing PEG may be sufficient; instead, the PEG (or PEG-based PPA composition) should be melt blended at sufficiently high temperature and/or specific energy input (total mechanical energy forced into a polymer per unit weight, e.g., J/g, a metric for extent of mixing) with the polymer to achieve adequate homogenization among PEG and polymer. For instance, melt-blending such as through melting and then co-extrusion of the PEG and polymer (e.g., in a compounding extruder) under elevated temperature (e.g., 150° C. or more, such as 200° C. or more) can achieve adequate homogenization, while simply melting the PEG and tumble-blending with polymer does not achieve adequate homogenization. Thus, methods of various embodiments include mixing the PEG and polymer (e.g., polyethylene) in a manner that ensures both components melt during the mixing (e.g., melt-mixing, coextrusion in a compound extruder). Preferred methods according to some embodiments include melt-blending and coextruding the PEG and polymer (and optional other additives) in a compounding extruder, and pelletizing the mixture upon its exit from the extruder, thereby locking the homogenously blended mixture in place. More specifically, such methods can include: (a) feeding a PEG composition and a polymer (e.g., polyethylene) into an extruder (optionally with other additives); (b) coextruding the PEG composition and polymer in the extruder at an elevated temperature suitable for melting both the PEG and the polymer (e.g., 200° C. or higher); and (c) pelletizing the extrudate to form the polymer composition comprising the PEG-based PPA. Preferably, the extrusion is carried out under oxygen-poor atmosphere (e.g., nitrogen atmosphere).

In the above discussion, as with other discussions herein, where “PEG” is referenced, a PEG masterbatch or PEG composite may be substituted therefor, as long as the relative amounts of PEG delivered to a polymer composition via masterbatch remain consistent with amounts of PEG alone that would be delivered to the polymer composition.

### Films

As noted, a significant reason for employing PPAs is to eliminate melt fracture in blown films. Ideally, when replacing incumbent PPAs with the PEG-based PPA composition of the present disclosure, films made from polymer compositions including such PEG-based PPA composition will exhibit similar or superior properties as compared to films made using polymer compositions comprising conventional PPA.

Thus, the invention of the present disclosure can also be embodied in a film made from any of the above-described polymer compositions (and in particular, polyethylene compositions) comprising the polymer and 250 to 15000 ppm (such as 250 to 11000 ppm, such as 800-2800 ppm) of the PEG (having Mw less than 10,000 g/mol; such as within the range from 6,500 to 9,500 g/mol), and preferably being free or substantially free of fluorine and/or fluorine-containing compounds; wherein the film has one or more of (and preferably all of):
1% secant modulus (MD) within +/−5% psi, preferably within +/−1% psi, of the value (psi) of a film that is made using a fluoropolymer-based PPA instead of the PEG-based PPA composition, but is otherwise identical;
Elmendorf tear (MD) within +/−10% g, preferably within +/−5% g, of the value (g) of a film that is made using a fluoropolymer-based PPA instead of the PEG-based PPA composition, but is otherwise identical;
Total haze within +/−25%, preferably within +/−10%, of the value (in %) of a film that is made using a fluoropolymer-based PPA instead of the PEG-based PPA composition, but is otherwise identical, and/or total haze less than 6%;
Gloss (MD) within +/−12%, preferably within +/−10%, of the value (in GU) of a film that is made using a fluoropolymer-based PPA instead of the PEG-based PPA composition, but is otherwise identical; and
Dart within +/−25%, preferably within +/−20% or even within +/−15%, of the value (g) of a film that is made using a fluoropolymer-based PPA instead of the PEG-based PPA composition, but is otherwise identical.

Further, in the discussion above, a film “made using a fluoropolymer-based PPA instead of the PEG-based PPA composition, but is otherwise identical” is intended to mean that a film made using an effective amount of PEG PPA composition is compared against a film made using an effective amount of fluoropolymer-based PPA; not necessarily that the same amount of each PPA is used. An effective amount is such that visible melt fractures are eliminated from the film, consistent with the discussion in connection with Example 1.

### EXAMPLES

To facilitate a better understanding of the embodiments of the present invention, the following examples of preferred or representative embodiments are given.

### Examples 1 and 2

Blown film trials were conducted on two blown film extruder lines, L1 and L2, to demonstrate a general usage of the inventive PPA formulations. Both lines were operated using a mono film annular die with the following conditions: a blowup ratio of 2.5, a die temperature set point of 390° F., a film gauge of 3 mil, a die gap of 30 mil, and a frost line height of approx. 5 times the die diameter. L1 has a die diameter of 160 mm, while L2 has a die diameter of 51 mm.

Initially for preparing for the trials on line L1, the L1 film line extruder was fed with a blend of a preceding polyethylene with Polybatch® KC 30 (a polyethylene-based cleaning and purging compound from A. Schulman, Inc.) in a 2:1 weight ratio (of preceding PE to KC 30 cleaning compound) for at least 30 minutes. The purpose of this initial step was to remove contaminants and potential PPAs from the metal surfaces inside the extruder and die. For all trial runs, the preceding polyethylene used in this step is the PPA-free version of the same polyethylene used in connection with the PPAs investigated herein. In all runs in connection with this Example 1, the mLLDPE used was Exceed™ 1018 polyethylene, an ethylene-hexene copolymer available from ExxonMobil Chemical Company having 0.918 g/cm³ density and 1.0 g/10 min MI, with MIR of 16.

Second, the film line was stopped and the inner die was manually polished to remove the KC 30 material.

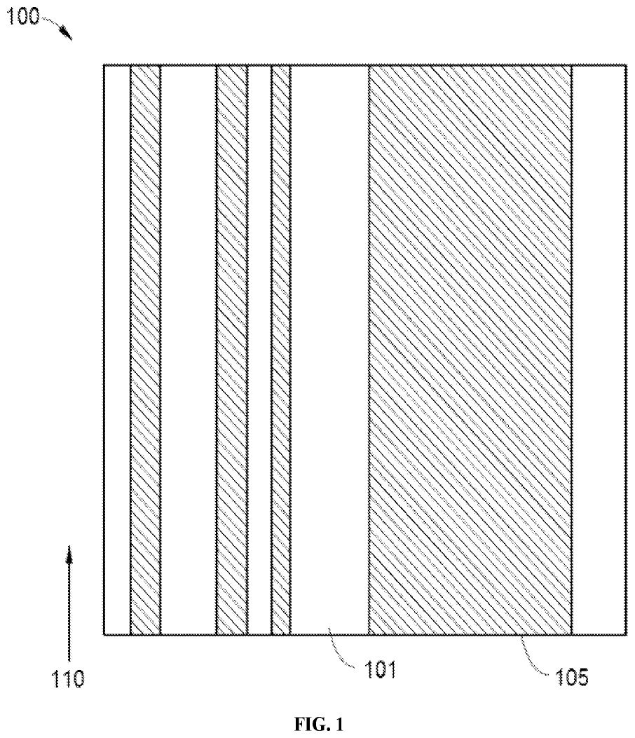

Third, the inner die was reinserted and the line was resumed with a pure feed of the same preceding mLLDPE material for 1 hour, until residual KC 30 was removed and melt fracture developed on the entirety of the film surface made from the mLLDPE. Fourth, a conventional fluoropolymer-containing PPA (DYNAMAR™ FX5929M) was fed to the extruder at constant mass flow rate which matched the mass flow rate of the mLLDPE. As PPA was fed, the melt fractures slowly began to disappear in streaks as illustrated in FIG. 1. With reference to FIG. 1, as the PPA is added, melt fracture-free regimes begin to emerge as stripes 101 in the machine direction 110 of the film 100 (that is, the direction in which the film is extruded and blown). FIG. 1 is a schematic conceptually illustrating this transitory period with streaks 105 of melt-fractured film material, and the stripes 101 of melt fracture-free film. Over time, these stripes 101 grow in width and the melt fracture zones diminish, and are eventually eliminated completely. This trial, using the mLLDPE noted and the conventional PPA, is denoted as C1 in Table 1 below. Table 1 summarizes the PPA and mLLDPE used in each trial (with the PPA-free version of that mLLDPE used as the preceding material in each case, as outlined above), further noting that outputs of all trial films normalized for annular die circumference (lbs/hr.-in. die) were maintained within +/−30% of each other.

The process was repeated for trial run 123, which took place in the same manner as described above for trial run C1, and using the same mLLDPE, except the inventive PEG-based PPA (in this case, Pluriol® E 8000, generically labeled as PEG 8K) was used at the amount indicated in Table 1, instead of the conventional PPA used in trial run C1. And the process was again repeated for trial runs 125 and 126, all on line L1 as indicated in Table 1 below, with increasing amounts of PEG 8K as also indicated in Table 1. These L1 trials are considered as Example 1. This sequence was repeated for trial run C2 (conventional PPA) and inventive runs I27-I30 on line L2, also as indicated in Table 1 below, and considered as Example 2. Table 1 further indicates the results of each trial run: melt fracture @ 100 min (% of area of the film) and time to melt fracture elimination (in min), with faster times of course being better.

TABLE 1
Inventive and comparative examples on
Lines L1 (Example 1) and L2 (Example 2)

| | | | Melt | Time to | | |
|---|---|---|---|---|---|---|
| | | | fract. | Melt | | |
| | | | @ | fract. | Initial | Final |
| | | | 100 | elimina- | extruder | extruder |
| | | Film | min | tion | pressure | pressure |
| ID | PPA | Line | (%) | (min) | (psi) | (psi) |
| C1 | 400 ppm | L1 | 0 | 22 | 7900 | 6370 |
| | reference | | | | | |
| I23 | 250 ppm PEG 8K | L1 | 80 | N/A | 7900 | 7160 |
| I24 | 500 ppm PEG 8K | L1 | 7 | N/A | 7690 | 7150 |
| I25 | 750 ppm PEG 8K | L1 | 0 | 52 | 7520 | 6730 |
| I26 | 1000 ppm PEG 8K | L1 | 0 | 37 | 7860 | 6660 |
| C2 | 400 ppm | L2 | 0 | 103 | 5400 | 4080 |
| | reference | | | | | |
| I27 | 250 ppm PEG 8K | L2 | 2 | N/A | 5330 | 4860 |
| I28 | 500 ppm PEG 8K | L2 | 0 | 42 | 5255 | 4745 |
| I29 | 750 ppm PEG 8K | L2 | 0 | 85 | 5350 | 4650 |
| I30 | 1000 ppm PEG 8K | L2 | 0 | 61 | 5425 | 4800 |

For each trial run, the time at which PPA feed was begun was recorded as time T=0, and extent of melt fracture on each extruded film was observed as a percentage of the surface area of the film including melt-fracture streaks (see FIG. 1 and discussion above) versus duration of PPA feed.

In this manner, effectiveness of the PPAs could be judged in eliminating melt fracture in the resulting blown films. In Table 1, it can be seen that 126 and 125 (having 750 ppm and 1000 ppm PEG 8K, respectively) compare favorably to the melt fracture elimination achieved with the conventional PPA on the L1 line (Example 1).

Surprisingly, on the L2 line (Example 2), the PEG 8K actually out-performed the conventional PPA at these same loadings (see 128, 129 and 130, for 500, 750 and 1000 ppm PEG 8K, respectively). It is hypothesized that this may be due in part to faster diffusivity of the PEG 8K compared to conventional PPA, having a more pronounced effect on speed of melt fracture reduction when extruding at lower specific outputs.

### Example 3

Example 3 reports the investigation of the effect of different polyethylene resin properties on melt fracture elimination using the PEG 8K as a PPA, and also investigates the effect on melt fracture elimination of slip and antiblock additives in conjunction with the PPA. The resins and additive packages investigated in connection with this example are summarized in Table 2 below (where MI, density, and MIR are each determined according to the methods already described herein). Each polyethylene of Table 2 is a metallocene-catalyzed LLDPE that is a copolymer of ethylene and hexene, with further properties as noted below. It is further noted that the PE used in Examples 1 and 2 is also included in Table 2 for easy reference. All Example 3 runs were carried out on the compound extruder line L2 as described in Examples 1 and 2, using the polyethylenes and additive packages of Table 2 in place of the polyethylene used in Examples 1 and 2. Output rates (lbs/hr-in. die) were again within +/−30% of each other for each set of trials in each respective Table 3-7 below.

TABLE 2
PE grades used, in order of example ID.

| PE Ref. | Density | MI | MIR | Non-PPA additives | Architecture |
|---|---|---|---|---|---|
| Exs. 1, 2 | 0.918 | 1 | 16 | Primary/secondary antioxidants | Linear |
| 3-1 | | | | Primary/secondary antioxidants, | Linear |
| | 0.918 | 1 | 16 | antiblock, slip | |
| 3-2 | | | | Primary/secondary antioxidants, | Some long-chain branching |
| | 0.923 | 0.48 | 40 | antiblock, slip | |
| 3-3 | 0.938 | 0.28 | 58 | Primary/secondary antioxidants | Some long-chain branching |
| 3-4 | | | | Primary/secondary antioxidants, | Linear |
| | 0.918 | 0.48 | 30 | antiblock, slip | |
| 3-5 | 0.915 | 0.48 | 29 | Primary/secondary antioxidants | Linear |

Table 3 below shows the results of melt fracture elimination in blown films made using different PEG 8K loadings with PE 3-1 on line L2. These data illustrate how PEG 8K is comparable to the reference PPA when a slip/antiblock additive package is employed. The reference PPA was faster here than in the slip/antiblock-free version considered in C2 in Example 2. Similarly, the 250 ppm PEG 8K loading level here of 132 was faster than the slip/antiblock-free version in I27 in Example 2.

TABLE 3
PPA performance on L2 for PE 3-1 (linear, 0.918 g/cc density,
1 MI, 16 MIR, antiblock/slip-containing metallocene PE).

| | | Melt | Time to Melt | Initial | Final |
|---|---|---|---|---|---|
| | | fracture | fracture | extruder | extruder |
| | | @ 100 | elimination | pressure | pressure |
| ID | PPA | min (%) | (min) | (psi) | (psi) |
| C31 | 600 ppm reference | 0 | 52 | 5200 | 4200 |
| I32 | 250 ppm PEG 8K | 0 | 52 | 5300 | 4900 |
| I33 | 500 ppm PEG 8K | 0 | 37 | 5115 | 4890 |
| I34 | 750 ppm PEG 8K | 0 | 52 | 5100 | 4700 |
| I35 | 1000 ppm PEG 8K | 0 | 22 | 5100 | 4800 |

Table 4 below shows the results of melt fracture elimination in blown films made using different PEG 8K loadings with PE 3-2 on line L2. These data illustrate how PEG 8K can eliminate melt fracture significantly faster for a different resin, and appears to be more sensitive than the reference PPA. It appears that the additive will respond depending on a resin's rheological properties. With this resin, its high MI makes it less melt fracture prone; it is possible that this allows the PEG 8K to more rapidly eliminate melt fracture.

TABLE 4
PPA performance on L2 for PE 3-2 (slightly branched,
0.923 g/cc density, 0.48 MI, 40 MIR, antiblock/slip-
containing metallocene PE).

| | | Melt | Time to Melt | Initial | Final |
|---|---|---|---|---|---|
| | | fracture | fracture | extruder | extruder |
| | | @ 100 | elimination | pressure | pressure |
| ID | PPA | min (%) | (min) | (psi) | (psi) |
| C36 | 500 ppm reference | 0 | 52 | 4800 | 4100 |
| I37 | 500 ppm PEG 8K | 0 | 50 | 4890 | 4675 |
| I38 | 750 ppm PEG 8K | 0 | 37 | 4850 | 4400 |
| I39 | 1000 ppm PEG 8K | 0 | 37 | 4815 | 4100 |

Table 5 below shows the results of melt fracture elimination in blown films made using different PEG 8K loadings with PE 3-3 on line L2. Perhaps due to the resin's low MI, both the reference PPA and the PEG 8K eliminate melt fracture more slowly than in previous grades, leaving behind thin strip of melt fracture that persist for long times. However, for PEG 8K, a higher loading level will satisfactorily reduce this elimination time. It is worth noting that the presence of moderate long-chain branching in PE 3-3, as well as lack of slip/antiblock, may also explain the slower melt fracture elimination.

TABLE 5
PPA performance on L2 for PE 3-3 (slightly branched, 0.938 g/cc
density, 0.28 MI, 58 MIR, antiblock-slip-free metallocene PE).

| | | Melt | Time to Melt | Initial | Final |
|---|---|---|---|---|---|
| | | fracture | fracture | extruder | extruder |
| | | @ 100 | elimination | pressure | pressure |
| ID | PPA | min (%) | (min) | (psi) | (psi) |
| C42 | 500 ppm reference | 0.1 | N/A | 4600 | 4230 |
| I43 | 500 ppm PEG 8K | 1.5 | N/A | 4730 | 4900 |
| I44 | 750 ppm PEG 8K | 0.1 | N/A | 4600 | 4800 |
| I45 | 1000 ppm PEG 8K | 0 | 67 | 4700 | 4850 |

Table 6 below shows the results of melt fracture elimination in blown films made using different PEG 8K loadings with PE 3-4 on line L2. While the reference PPA exhibited an initially faster response, it ultimately was not able to completely clear up the melt fracture, whereas the PEG 8K was able to do so for as low of a composition as 750 ppm.

TABLE 6
PPA performance on L2 for PE 3-4 (linear, 0.915 g/cc density,
0.48 MI, 30 MIR, antiblock-slip-containing metallocene PE).

| | | Melt | Time to Melt | Initial | Final |
|---|---|---|---|---|---|
| | | fracture | fracture | extruder | extruder |
| | | @ 100 | elimination | pressure | pressure |
| ID | PPA | min (%) | (min) | (psi) | (psi) |
| C46 | 600 ppm reference | 11 | N/A | 5650 | 4580 |
| I47 | 500 ppm PEG 8K | 2 | N/A | 5700 | 4755 |
| I48 | 750 ppm PEG 8K | 0 | 53 | 5530 | 4730 |
| I49 | 1000 ppm PEG 8K | 0 | 67 | 5500 | 4650 |

Table 7 below shows the results of melt fracture elimination in blown films made using different PEG 8K loadings with PE 3-5 on line L2. In this case, the PEG 8K outperformed the reference PPA based on melt fracture elimination. Furthermore, comparing Tables 6 and 7 is useful since the same PE is used in both, except Table 6 is for the resin with antiblock/slip additives (PE 3-4) while Table 7 is for the resin without those additives (PE 3-5). This revealed for this resin that melt fracture elimination generally occurred faster in the absence of slip and antiblock; although the results were quite similar in the case of 1000 ppm PEG 8K loading. Also, it is worth noting that for the case of the comparing the PE resin of Example 1 (without slip/antiblock) via Table 1 vs. the same PE resin with slip/antiblock (PE 3-1 of Example 3) via Table 3, we see the opposite trend: slip/antiblock led to faster melt fracture elimination (shown in Table 3) as compared to its absence (shown in Table 1). This discrepancy implies a potential resin dependence on the effect of slip and/or antiblock on PPA performance.

TABLE 7
PPA performance on L2 for PE 3-5 (linear, 0.915 g/cc density,
0.48 MI, 30 MIR, antiblock-slip-free metallocene PE).

| | | Melt | Time to Melt | Initial | Final |
|---|---|---|---|---|---|
| | | fracture | fracture | extruder | extruder |
| | | @ 100 | elimination | pressure | pressure |
| ID | PPA | min (%) | (min) | (psi) | (psi) |
| C50 | 500 ppm reference | 0 | 52 | 5650 | 4025 |
| I51 | 500 ppm PEG 8K | 0 | 40 | 5600 | 4750 |
| I52 | 750 ppm PEG 8K | 0.1 | N/A | 5500 | 4750 |
| I53 | 1000 ppm PEG 8K | 0 | 50 | 5750 | 4350 |
| I54 | 1200 ppm PEG 8K | 0 | 95 | 4985 | 3950 |

### Example 4

Exceed™ 1018 LLDPE with 1000 ppm PEG 8K incorporated therein was used for a further experiment making blown film, this time in blown film line L1. The line was run with a die gap of 60 mil, with relatively high die factor of 15.0 lbs/hr-in die (maintained with very high output rate) to test harsh operating conditions. First film sample was collected without issue as Sample 4-1; but after approximately 3 hours, tiny amounts of melt fracture were observed to re-develop and within seconds disappear. Over the next 3 hours, however, melt fracture became more persistent, such that by hour 6, melt fracture was regularly remaining in the film during extrusion and blowing. Then, continuous co-feeding of 5 wt % of PEG 8K masterbatch in LL1002.09 carrier resin was initiated to the blown film extruder (equivalent to 2000 ppm additional PEG, on top of the 1000 ppm PEG already in the resin, resulting in 3000 ppm PEG on basis of mass of the resin being extruded). Melt fracture was eliminated within 50 minutes. A further film sample, Sample 4-2 (having 3000 ppm PEG 8K), was collected.

The next day, the trial was again started with Exceed™ 1018 LLDPE with 1000 ppm PEG 8K, but with no co-feeding of the PEG masterbatch. Melt fracture developed again in a similar manner; this time, only 2.5 wt % of PEG 8K masterbatch in LL1002.09 carrier resin was initiated as co-feed to the blown film extruder, resulting in 2000 ppm PEG on basis of mass of the resin being extruded. The blown film was collected as Sample 4-3.

Table 8 below reports the processing conditions associated with each of Samples 4-1, 4-2, and 4-3, collected as described above; and also reports the total PEG loading in each sample, as well as various properties of the blown film.

TABLE 8
Films made with varying amounts of PEG 8K

| Sample ID | 4-1 | 4-2 | 4-3 |
|---|---|---|---|
| Resin/Masterbatch ID | 1018 + PEG | 1018 + PEG + | 1018 + PEG + |
| | | 5 wt % MB | 2.5% MB |
| Total PEG 8K Loading | 1000 ppm | 3000 ppm | 2000 ppm |
| Output (lb/h) | 300 | 300.7 | 299.6 |
| Die gap (mil) | 60 | 60 | 60 |
| Motor speed (RPM) | 42.3 | 43.8 | 50.3 |
| Die factor (lbs/hr-in die) | 15.0 | 15.0 | 15.0 |
| Melt Temperature (° F.) | 433 | 394 | 399 |
| Melt Pressure 1 (psi) before screenpack | 8524 | 9411 | 8769 |
| Melt Pressure 2 (psi) after screenpack | 6770 | 7744 | 7089 |
| MD Secant Modulus (psi) | 23,855 | 24,243 | 23,962 |
| TD Secant Modulus (psi) | 25,789 | 24,422 | 25,211 |
| Dart A Phenolic (g/mil) | 747 | 567 | 619 |
| MD Tear (g/mil) | 237.0 | 228.0 | 239.0 |
| TD Tear (g/mil) | 368.0 | 402.0 | 386.0 |
| MD Yield Strength (psi) | 1193 | 1208 | 1203 |
| TD Yield Strength (psi) | 1185 | 1197 | 1210 |
| MD Elong at Yield (%) | 5.4 | 5.7 | 5.6 |
| TD Elong at Yield (%) | 5.1 | 5.4 | 5.2 |
| MD Tensile Strength (psi) | 8,906 | 10,263 | 9,880 |
| TD Tensile Strength (psi) | 7,230 | 8,808 | 8,549 |
| MD Elongation at Break (%) | 527 | 523 | 509 |
| TD Elongation at Break (%) | 616 | 634 | 647 |
| Average Gauge (mil) | 0.98 | 0.99 | 0.98 |
| Puncture Peak Force (lb/mil) | 12.6 | 13.64 | 13.72 |
| Puncture Break Energy (in/lb/mil) | 40.53 | 52.48 | 51.25 |
| Heat Shrinkage (MD) (%) | 34 | 31 | 34 |
| Heat Shrinkage (TD) (%) | 1 | 0 | 3 |
| Kinetic COF (I/I) Average | 0.932 | 1.61 | 1.54 |
| Static COF (I/I) Average | 0.808 | 0.962 | 0.827 |
| Haze Total (%) | 27.3 | 23 | 28 |
| Gloss 45° @ MD (GU) | 25 | 32 | 23 |
| Gloss 45° @ TD (GU) | 25 | 33 | 23 |

While many of the film properties remain relatively comparable among the 3 samples, there are some marked differences. For example, while many of the film properties remained within approximately +/−10-15%, Dart A suffered a roughly 25% decrease when increasing PEG 8K loading to 3000 ppm, but with only 2000 ppm PEG loading, Dart A dropped only about 18%, more in-line with changes in the other film properties. This indicates that overloading PEG in an attempt to counter melt fracture can detrimentally impact desired film properties. Instead, a balanced approach with a targeted amount of PEG loading, even in response to harsh operating conditions, is called for.

### Example 5

A PEG solid composite was obtained, made up of a 50:50 (by weight) composite of PEG 8K compressed with Irgafos™ 168 phosphite antioxidant, available from BASF. The composite was fed via additive hopper into a finishing extruder of a gas phase polymerization process, where it was coextruded with Exceed™ 1018 mLLDPE and pelletized in amounts such that the mLLDPE pellets contained approximately 1000 ppm PEG. The PEG composite fed smoothly without sticking or other handling issues, and normal extrusion rate was maintained successfully, indicating the viability of the PEG composite in managing feed of PEG to an extruder for co-extrusion with polymer composition.

### Test Methods

Table 10 below reports the test methods used in connection with the Examples. Unless stated otherwise in the description of a given property, these methods are also to be used in determining properties in accordance with embodiments described herein.

TABLE 9
Measurement methods.

| Test Name or | |
|---|---|
| Parameter Name | Method or description |
| Melt index, high | ASTM D-1238 2.16 kg (melt index) or 21.6 kg (high load melt index), 190° C. |
| load melt index | |
| Melt index ratio | High load melt index/melt index |
| Density | ASTM D1505, column density. Samples were molded under ASTM D4703-10a, |
| | Procedure C, then conditioned under ASTM D618-08 (23° ± 2° C. and 50 ± 10% |
| | relative humidity) for 40 hours before testing |
| Percent melt fracture | Measured by eye. The fraction of melt fracture Estimated visually from a 2-ft |
| coverage | long sample of film, taken as a percentage of the area with noticeable, |
| | characteristic melt fracture roughness. Clear delineation existed between the |
| | melt fractured regions and the smooth, melt fracture free regions of the sample. |
| Pressure | Read off the in-line calibrated pressure transducer of the blown film line |
| | extruder, before the screen-pack, and recorded. |
| Die factor | Output (lb/hr)/die circumference (in). Output (lb/hr) = film sample weight (g, |
| | determined from a sample as measured on a tared, calibrated weight scale) × |
| | line speed (fpm, determined from an in-line tachometer) ÷ film sample length |
| | (in, measured by yard stick) × 1.59 lb-in-min/g-ft-hr |
| Die Gap | The spacing (mil) between inner and outer walls of an extrusion die. For |
| | example, where a die is such that polymer is extruded through the annulus |
| | defined by the outer wall of an inner cylinder, and the inner wall of an outer |
| | cylinder (which is concentric with the inner cylinder), the die gap is the |
| | measurement (distance, mil) between outer wall of the inner cylinder, and inner |
| | wall of the outer cylinder. |
| Specific output | Output (lb/hr)/extruder speed (rpm). Output is computed as with die factor. |
| | Extruder speed measured by in-line tachometer. |
| 1% Secant Modulus | ASTM D-882, 15 mm width strip |
| Yield Strength | ASTM D-882, 15 mm width strip |
| Tensile Strength | ASTM D-882, 15 mm width strip |
| Elongation at Break | ASTM D-882, 15 mm width strip |
| Elongation at Yield | ASTM D-882, 15 mm width strip |
| Dart Drop | ASTM D-1709, Phenolic, Method A |
| Haze | ASTM D-1003 |
| Gloss, 45° | ASTM D-2457 |
| Elmendorf Tear | ASTM D1922 with conditioning for 40 hours at 23° ± 2° C. and 50 ± 10% relative |
| | humidity |
| Puncture | Modified ASTM D5748: ASTM probe was used with two 0.25 mil HDPE slip |
| | sheets. Machine Model: United SFM-1. Testing speed: 10 in/min |
| Heat Seal | Method using 1 inch film strip of 1 mil gauge, sealed at various temperatures |
| | under 73 psi (0.5 N/mm²) for 1 second. Following conditioning for 40 hours at |
| | 23° ± 2° C. and 50 ± 10% relative humidity, the sealed specimen were tested in |
| | T-joint peel mode at 20 inch/min pulling speed |

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

While the present disclosure has been described with respect to a number of embodiments and examples, those skilled in the art, having the benefit of this disclosure, will appreciate that other embodiments can be devised which do not depart from the scope and spirit of the present disclosure.

We claim:

1. A process for making a polymeric film, the process comprising:
a. for a first time interval, continuously extruding a polymer composition through an extruder at extrusion conditions to form the polymeric film;
b. at a first time endpoint during the continuous extrusion, developing one or more melt fractures in the polymeric film;
c. in response to developing the one or more melt fractures in the film, continuously feeding a PPA masterbatch to the extruder during a second time interval after the first time interval; and
d. obtaining the polymeric film during at least the second time interval;
wherein the PPA masterbatch comprises:
i. 1 to 50 wt %, on basis of mass of the masterbatch, of polyethylene glycol having weight average molecular weight (Mw) less than 10,000 g/mol;
ii. a carrier resin; and
iii. optionally, one or more non-PPA additives; and
further wherein no PPA additives other than the PEG are introduced to the extruder during the extruding, and wherein the polymeric film is substantially free of fluorine and fluorine-containing compounds.

2. The process of claim 1, wherein the polymer composition is a linear low density polyethylene (LLDPE) and the carrier resin is the same or a different LLDPE.

3. The process of claim 1, wherein the polymer composition comprises 500-1600 ppm of polyethylene glycol, and wherein the polyethylene glycol of the polymer composition has Mw less than 10,000 g/mol.

4. The process of claim 1, wherein the polymeric film obtained during the second time interval comprises 800-2800 ppm of polyethylene glycol, and wherein the polyethylene glycol of the film has Mw less than 10,000 g/mol.

5. The process of claim 1, wherein the extrusion conditions include one or more of: (1) a die gap of 60 mil or less; (2) a die factor of 15 lbs/(hr*in die) or greater; and (3) an Extrusion Processing Factor (EPF=100×[die factor]/[die gap]²) of 0.4 or greater, wherein die factor is in lbs/(hr*in die) and die gap is in mil.

6. The process of claim 5, wherein the polymer composition comprises 700-1500 ppm of polyethylene glycol; and wherein the PPA masterbatch is added such that the polymeric film obtained during the second time interval comprises 1500-2800 ppm of polyethylene glycol; wherein the polyethylene glycol of the polymeric film has Mw less than 10,000 g/mol.

7. The process of claim 1, wherein all polyethylene glycol of the polymeric film has Mw within the range from 6,500-9,500 g/mol.

8. The process of claim 1, wherein 2 to 6 wt % of PPA masterbatch is added, on the basis of mass of the polymeric film; and wherein the PPA masterbatch comprises 1 to 5 wt % of polyethylene glycol, on basis of mass of the masterbatch.

9. The process of claim 1, wherein the one or more non-PPA additives are selected from the group consisting of: UV stabilizers, slip agents, primary antioxidants, secondary antioxidants, and antiblock agents.

10. The process of claim 1, wherein the carrier resin is Ziegler Natta-catalyzed LLDPE having one or more of the following properties: (i) melt index (I₂, determined at 190° C., 2.16 kg loading) within the range from 1.5 to 5 g/10 min; (ii) molecular weight distribution (Mw/Mn) of 3.5 or greater; and (iii) density within the range from 0.910 to 0.935 g/cm³.

11. The process of claim 1, wherein the PPA masterbatch comprises 1 to 5 wt % of the PEG, on the basis of mass of the masterbatch.

12. The process of claim 1, wherein the polymer composition is metallocene-catalyzed LLDPE copolymer of ethylene and a C₃ to C₁₂ comonomer, and has one or more of the following properties: melt index (I₂, determined at 190° C., 2.16 kg loading) within the range from 0.1 to 1.5 g/10 min; density within the range from 0.905 to 0.945 g/cm³; and melt index ratio (MIR) within the range from 10 to 85.

13. A polymer processing aid (PPA) masterbatch consisting essentially of:
a. 1 to 50 wt %, on basis of mass of the masterbatch, of polyethylene glycol (PEG) having weight average molecular weight (Mw) less than 10,000 g/mol;
b. a polyethylene carrier resin selected from gas phase-polymerized linear low density polyethylene (LLDPE) or high-pressure free radical-polymerized low density polyethylene (LDPE); and
c. optionally, one or more non-PPA additives each selected from the group consisting of: UV stabilizers, slip agents, primary antioxidants, secondary antioxidants, and antiblock agents.

14. The masterbatch of claim 13, wherein the PEG has Mw within the range from 6,500 to 9,500 g/mol.

15. The masterbatch of claim 13, having 1 to 5 wt % of the polyethylene glycol.

16. The masterbatch of claim 13, wherein, when present, the one or more non-PPA additives are collectively present in the masterbatch in an amount between 200 ppm and 5000 ppm, on basis of mass of the masterbatch.

17. The masterbatch of claim 13, wherein the masterbatch includes one or more UV stabilizers selected from the group consisting of: hindered amine light stabilizers, triazines, hydroxyphenyl triazines, benzotriazoles, hydroxyphenyl benzotriazoles, benzophenones, hydroxybenzophenones, cyanoacrylates, oxanilides, organo-nickel compounds, and combinations thereof.

18. The masterbatch of claim 13, wherein the masterbatch includes a slip agent selected from the group consisting of: oleamide, erucamide, stearamide, behenamide, oleyl palmitamide, stearyl erucamide, ethylene-bis-stearamide, ethylene-bis-oleamide, and combinations thereof.

19. The masterbatch of claim 13, wherein the masterbatch includes a primary antioxidant and/or a secondary antioxidant;
wherein the primary antioxidant is selected from the group consisting of: hindered alkyl phenols, Vitamin E, and hydroxylamines; and
further wherein the secondary antioxidant is selected from the group consisting of: monophosphites, disphosphites, and combinations thereof.

20. The masterbatch of claim 13, wherein the masterbatch includes an antiblock agent selected from the group consisting of: talc, crystalline and amorphous (fumed) silica, nepheline syenite, diatomaceous earth, clay (e.g., kaolin clay), zeolites, and combinations thereof.

21. The masterbatch of claim 13, wherein the carrier resin is Ziegler Natta-catalyzed LLDPE having melt index (I₂, determined at 190° C., 2.16 kg loading) within the range from 1.5 to 5 g/10 min and density within the range from 0.910 to 0.935 g/cm³.

22. A process for making a polymeric film using the PPA masterbatch of claim 13, the process comprising:
a. Continuously extruding a polymer composition through an extruder at extrusion conditions to form the polymeric film;
b. for at least a first time interval during the extruding, feeding the PPA masterbatch to the extruder so that the PPA masterbatch and polymer composition are coextruded through the extruder; and
c. continuously obtaining the polymeric film during the first time interval, wherein the polymer product is substantially devoid of fluorine and fluorine-containing compounds.

23. The process of claim 22, wherein the polymer composition is a linear low density polyethylene (LLDPE) comprising 500 to 1300 ppm of polyethylene glycol; and further wherein the PPA masterbatch is fed to the extruder in an amount such that the polymeric film comprises 1500-2500 ppm of polyethylene glycol.

24. The process of claim 22, wherein the extrusion conditions include one or more of: (1) a die gap of 60 mil or less; (2) a die factor of 15 lbs/(hr*in die) or greater; and (3) an Extrusion Processing Factor (EPF=100×[die factor]/[die gap]²) of 0.4 or greater, wherein die factor is in lbs/(hr*in die) and die gap is in mil.

25. The process of claim 22, wherein the polymer composition is gas-phase polymerized, metallocene-catalyzed LLDPE having one or more of the following properties: melt index (I₂) within the range from 0.5 to 1.5 g/10 min; density within the range from 0.900 to 0.930 g/cm³; and melt index ratio (MIR) within the range from greater than 20 to 50.
